(19) United States
(12) Patent Application Publication
(10) Pub. No.: US 2009/0018871 A1
(43) Pub. Date: Jan. 15, 2009

(54) Consumer-driven pre-production vaccine reservation system and methods of using a vaccine reservation system

(76) Inventors: John R. Essig, Fairfax, VA (US); James M. Essig, Fairfax, VA (US); Maryanne E. Essig, Fairfax, VA (US); Kathryn G. Essig, Arlington, VA (US)

Correspondence Address: THE NATH LAW GROUP, 112 South West Street, Alexandria, VA, 22314, US

(21) Appl. No.: 12/003,787

(22) Filed: Dec. 31, 2007

Related U.S. Application Data
(63) Continuation-in-part of application No. PCT/US2005/023581, filed on Apr. 30, 2006.

(51) Int. Cl. G06Q 50/00; G06Q 30/00; G06Q 10/00

(52) U.S. Cl. 705/3; 705/26; 705/2; 705/14; 705/30

(57) ABSTRACT

The present inventive subject matter relates to an automated, consumer-driven, pre-production, seasonal vaccine reservation system for facilitating the efficient production, distribution, and/or administration of health-critical, long-production-lead-time seasonal vaccines, or other pharmacological agents, whereby use of such a consumer-driven vaccine reservation system provides a highly effective means for substantially ensuring or guaranteeing that consumer demand for seasonal vaccine can be fully and consistently met, but without subjecting the producers of vaccine and/or other cognizant parties associated with the healthcare industry to undue financial risk. In addition to the physical elements comprising such a consumer-driven vaccine reservation system, the present invention also represents various unique operational methods for accurately matching seasonal vaccine supply with seasonal consumer demand, thereby substantially facilitating production, distribution, and/or timely administration of vaccine.

This application is a continuation-in-part of International Application No. PCT/US2005/023581, filed Jun. 30, 2005, the contents of which, including the Article 34 amendments filed Apr. 30, 2006, are hereby incorporated by reference in their entirety.

### BACKGROUND OF THE INVENTION

1. Field of the Invention

The present invention relates most broadly to computer-implemented electronic systems, which provide improved methods for accurately matching seasonal vaccine supply with seasonal consumer demand, including improved methods for managing the production, distribution, administration, and/or post-administration evaluation of seasonal vaccine (or other health-critical or life-critical pharmacological agents).

More specifically, the present invention, in its preferred embodiments, relates to substantially automated, consumer-driven, pre-production, vaccine reservation systems for facilitating the efficient production, distribution, administration, and/or post-administration evaluation of health-critical, long-production-lead-time seasonal vaccines (e.g., influenza or “flu” virus vaccine), whereby use of such a consumer-driven vaccine reservation system provides an effective means for ensuring that consumer demand for seasonal vaccine can be fully and consistently met, but without subjecting the producers of vaccine, public health agencies, medical practitioners, and/or other cognizant parties within the broader healthcare industry to unnecessary financial risk.

2. Industry Background

Briefly, to meet the needs of healthcare consumers for annual or seasonal vaccines (e.g., influenza or “flu” virus vaccine), the healthcare industry along with cognizant governmental health agencies currently expend a considerable amount of time, effort, and financial resources to ensure that such annual or seasonal vaccines are generally produced and distributed in quantities sufficient to fully meet consumer demand (i.e., every person who wishes to receive a vaccine has the opportunity to do so, although often for a fee). However, the healthcare industry and the cognizant governmental health agencies also expend a considerable amount of time, effort, and financial resources to avoid the wasteful expense associated with excessive overproduction of unwanted vaccine, which, if unused during a particular season, typically must be destroyed as a result of its limited shelf life and/or obsolescence. Accordingly, healthcare industry professionals and/or government authorities are thus generally required to simultaneously meet, to the greatest extent possible, two often-competing objectives: (1) providing good health care (e.g., ensuring full access to vaccine), and (2) avoiding excessive financial expense (e.g., avoiding gross overproduction of vaccine).

To reliably meet both of these objectives, the broader healthcare industry requires an accurate method of matching seasonal vaccine supply (i.e., establishing production and/or distribution quantities) with seasonal consumer demand for vaccine. However, due in large part to the lengthy process of vaccine production, the highly variable nature of consumer demand, and the variable and somewhat unpredictable nature of various pathogens (such as influenza virus), the healthcare industry and governmental health agencies currently experience great difficulty—and only limited success—in their yearly attempts to accurately match seasonal vaccine supply with seasonal vaccine demand.

In greater detail, first note that producers of vaccine would ideally prefer to produce vaccine based on known consumer demand during the season (e.g., the “flu” season). Unfortunately, the production-lead-time for vaccine is sufficiently long in duration (e.g., approximately four months in duration using existing mass production methods for influenza virus vaccine) such that it is not currently economically and/or temporally viable to produce vaccine based on consumer demand during the season. As a result, producers must instead attempt to accurately estimate or forecast (via previous statistics) the demand for vaccine during the upcoming season, and then commit to specific production quantities several months before actual consumer demand is known. Further, while all forecasts are generally subject to some amount of error, this particular forecasting exercise is made much more difficult by the highly variable (and often fickle) seasonal demand for vaccine, which generally fluctuates in direct response to the perceived seasonal threat by the healthcare consumer to a given pathogen or strain thereof. Difficulties in forecasting demand are further exacerbated by the fact that certain pathogens, such as influenza, tend to mutate and/or breakout regularly, yet unreliably, and with unknown severity. Further, mass-media and, more specifically, its ability to induce significant levels of hysteria within the broader population, can radically alter the demand for seasonal vaccine, long after the producers of vaccine were required to establish production quantities and commence production.

Ultimately, the current methods used to forecast seasonal vaccine demand (and, thus, establish accurate production quantities) are, in practice, as much an art as they are a science. Consequently, such forecast-based methods tend to be highly unreliable and, thus, expose both the consumers of vaccine and the producers of vaccine to considerable risks.

3. Related Art

a. Description of Prior Art

A multitude of different reservation systems exist throughout the world for various commercial and non-commercial activities; however, the related art of interest—principally in the form of current or conventional operational practices within the broader healthcare industry for matching seasonal vaccine supply with seasonal vaccine demand—does not disclose or suggest the present invention.

Briefly, prior related art does provide various methods for attempting to match seasonal vaccine supply and demand. However, all such methods of prior art typically attempt to match supply and demand by estimating or forecasting future demand for seasonal vaccine (and thus establish production and/or distribution quantities for seasonal vaccine) based largely on (1) the historical consumer demand for similar vaccine during prior seasons and/or (2) the perceived or estimated relative seasonal pathogenic threat during the upcoming season.

It should be noted such prior art is principally embodied within the open literature and/or evidenced by the common knowledge of those having professional experience in a related field. Accordingly, no specific prior art references (e.g., patents and the like) are cited herein. Nonetheless, a closer review of prior art (i.e., the commonly-known conventional operational practices within the healthcare industry for determining vaccine production and/or distribution quantities) clearly reveals its many limitations.

Regarding the limitations of prior art, as previously noted, any forecast-based method for matching seasonal supply of vaccine with seasonal demand (i.e., determining adequate production and/or distribution quantities) generally entails a highly error-prone “compromise” between the two critically important, yet typically competing, simultaneous objectives of (1) ensuring full access to vaccine and (2) avoiding the expense and waste of gross overproduction. To minimize the adverse consequences of the methods of prior art, note that the associated compromise, which is typically embodied in the form of a pre-season decision or commitment to a specific production quantity, is historically intentionally biased toward a moderate amount of overproduction, so as to provide an adequate margin of safety between supply and demand.

If such competing objectives are managed successfully for a given season, only a small amount of excess vaccine is produced, thereby resulting in limited waste. Although seemingly affordable, it should be emphasized that even a moderate amount of overproduction can be very expensive. However, as a result of the inherent difficulties in managing these competing objectives using such forecast-based methods of prior art (once again, the difficulty is due in large part to the lengthy process of vaccine production, the highly variable and often fickle nature of consumer demand, and the variable and somewhat unpredictable nature of various pathogens), the forecast-based methods of prior art expose both the consumers of vaccine and the producers of vaccine to considerable risk. Further, as will be shown below, such long-established, industry-standard, forecast-based methods for matching seasonal supply of vaccine with seasonal demand have been (and remain) dangerously inaccurate.

More specifically, it is important to note that these two competing objectives of (1) providing good health care (e.g., ensuring full access to vaccine) and (2) avoiding excessive or unnecessary financial expense (e.g., avoiding gross overproduction) are generally applicable world-wide; however, these competing objectives are of critical importance in regions of the world having market-driven, free-enterprise-based, healthcare systems, such as that currently found within the United States of America (US). In greater detail, note, for example, that present annual vaccine production quantities in such market-driven economies (e.g., the US) are, once again, generally based on historical annual or seasonal consumer demand for vaccine, although production quantities are typically adjusted for the relative perceived threat or risk (as perceived by healthcare industry professionals and/or personnel representing governmental health agencies) during the upcoming “season” from new, highly infectious, and/or highly lethal strains of a pathogen (e.g., influenza or “flu” virus). Although the producers of vaccine working in concert with medical practitioners, governmental health agencies, and/or other organizations, are generally able to forecast with somewhat reasonable accuracy the consumer demand for a given year or season, major shortages (as well as excessive overproductions) of vaccine, nonetheless, can occur (and historically do occur) resulting in severe consequences.

As one example of the failings of forecast-based methods of prior art, first note that as a result of the unexpectedly low demand for influenza vaccine in the Unites States during the 2002-2003 “flu” season, many doses of vaccine went unused, thereby representing a significant financial loss to the producers of the vaccine and/or others within the healthcare industry.

As a second example of the failings of prior art, note that in response to the unexpectedly low demand for flu vaccine during the 2002-2003 flu season, the producers of vaccine reduced production quantities for the 2003-2004 flu season based, in part, on the prior flu season's low demand. Unfortunately, the 2003-2004 flu season commenced early and with unusual severity, thereby causing (1) all readily available doses of vaccine to be consumed very early within the flu season and (2) a general shortage of vaccine in most regions of the country. It is strongly emphasized that this shortage in vaccine supply resulted in unnecessary illness, loss of life, loss of time at work and/or school, long waiting lines for vaccine administration, rationing of vaccine by government and health care providers, general panic or hysteria within certain susceptible sectors of the population, and numerous other adverse consequences to society—all because the forecast-based methods of prior art for matching seasonal vaccine supply and seasonal vaccine demand were highly inaccurate for the given season.

As a third example of the failings of prior art, note that in response to the shortage of flu vaccine experienced during the 2003-2004 flu season, the producers of vaccine substantially increased production quantities for the 2004-2005 flu season based, in part, on the supply shortage experienced during the prior flu season. Unfortunately, manufacturing difficulties (in particular, the contamination of vaccine during production at one major producer) caused the irrecoverable loss of approximately half (or approximately 50 million doses) of the nation's flu vaccine supply for the 2004-2005 flu season. Consequently, for the second consecutive flu season, severe shortages of flu vaccine existed throughout most regions of the country. As might be expected, this shortage in vaccine supply resulted, once again, in unnecessary illness, loss of life, loss of time at work and/or school, long waiting lines for vaccine administration, rationing of vaccine by government and health care providers, general panic or hysteria within certain susceptible sectors of the population, and numerous other adverse consequences to society—all because the forecast-based methods of prior art for matching seasonal vaccine supply and seasonal vaccine demand were, once again, highly inaccurate for the given season.

Considering these examples, it is clearly evident that the current forecast-based methods of prior art for establishing vaccine production quantities present very significant risks, both on the supply side to producers, and on the demand side to consumers.

Regarding the demand-side risks to healthcare consumers, note that these risks are greatest to young children, the elderly, and/or those with weakened immune systems, all of whom should generally receive flu vaccine seasonally. However, under the methods of prior art, note that these persons currently have no means for ensuring that vaccine will be available to them, thereby placing their health at risk. Worse, for some of these healthcare consumers who might be classified as “high-risk”, reliable access to seasonal vaccine is often critical to the maintenance of health and/or the preservation of life.

Regarding the supply-side risk to the producers of vaccine, first note that such for-profit healthcare enterprises will expectedly make every effort to minimize unnecessary financial risk. Further, such producers simply cannot afford to produce vaccine for all those who might want it: to do so would require the producers to produce several times (e.g., three to five times) the typical seasonal demand for vaccine, the vast majority of which would go unused. Ultimately, such excess margin or overproduction would, at least, be wasteful, if not financially damaging or devastating to the producers of vaccine and/or to the government health agencies (or other entities) securing the producer's investment.

b. Disadvantages of Prior Art

In summary, the forecast-based methods of prior art for matching seasonal vaccine supply and seasonal vaccine demand represent numerous disadvantages, both to the vaccine consumer and to the vaccine provider. These many disadvantages of prior art include, but are not limited to:

1. Prior art fails to provide any effective means for substantially ensuring an individual consumer access to one or more seasonal vaccines (or to a particular medically-required type or form of vaccine), thereby seasonally exposing the intended vaccine consumer to unnecessary risk of infection, illness, loss of work or income, other adverse consequences, and possibly death.

2. Prior art fails to provide any reliable means for accurately matching seasonal vaccine supply and demand (i.e., establishing accurate production and/or distribution quantities), often leading to significant overall and/or local imbalances between vaccine supply and demand. In addition to possibly subjecting the involved parties to severe health and/or economic consequences, prior art also frequently forces personnel within the health care industry and/or government health agencies to implement contingency plans to manage a significant vaccine shortage and/or the consequences thereof.

3. Prior art fails to provide any effective means for capturing or securing production costs (or a proxy thereof) from the consumer (and/or the consumer's representative or agent) prior to vaccine delivery and administration, thereby subjecting such producers and/or their financial underwriters (including governmental health agencies) to unnecessary financial risk.

4. Prior art fails to provide any effective means for accurately capturing or obtaining from consumers and providing to the vaccine producers geographical information regarding the intended vaccine consumers, thereby making accurate and timely geographical distribution of vaccine unnecessarily difficult. Thus, the methods of prior art result in the possibility (and real occurrences) of local shortages and/or local oversupply, regardless of the overall balance between supply and demand.

5. Prior art fails to provide any effective means for prompting and/or incentivizing consumers to actually be vaccinated. Additionally, other than by general medical appointments or office visits, prior art provides no readily accessible means for scheduling a simple vaccination, many of which are given outside the medical office (for example, in a community school gymnasium, a local grocery store or pharmacy, and the like), and therefore generally cannot effectively utilize the existing medical infrastructure for appointments.

6. Prior art fails to provide any effective means for post-vaccination evaluation of one or more vaccines or other pharmacological agents.

7. Prior art fails to provide any effective means for allowing individuals or other benefactors to charitably gift or donate one or more vaccines to those in need of vaccine, but having insufficient financial means.

8. Prior art fails to provide any effective means for educating the vaccine consumer regarding (1) general and/or specific pathogenic risks or (2) vaccines which might be available to mitigate or eliminate such risks. In addition, prior art fails to provide to the vaccine consumer any effective means for planning or managing personal vaccinations over time.

As one reads subsequent sections of this document, it will become quite clear that prior art has numerous other disadvantages.

Accordingly, there remains a continuing general need within the global healthcare industry for an accurate method of matching annual or seasonal supply of vaccine (i.e., production and/or distribution quantities) with seasonal consumer demand. These unfulfilled needs clearly underscore the value of the present invention, which fully and uniquely meets each of these needs.

### SUMMARY OF THE INVENTION

The present invention, in its preferred embodiments, is an automated, consumer-driven, pre-production, seasonal vaccine reservation system for facilitating the efficient production, distribution, and administration of health-critical, long-production-lead-time seasonal vaccines (or other pharmacological agents), whereby use of such a consumer-driven vaccine reservation system provides an effective means and/or method for substantially ensuring or guaranteeing that consumer demand for seasonal vaccine can be fully and consistently met, but without subjecting the producers of vaccine and/or other cognizant parties associated with the healthcare industry to undue financial risk. In addition to the physical elements comprising such a consumer-driven vaccine reservation system, the present invention also represents various unique operational methods including, among others, heretofore unrealized methods for accurately (e.g., precisely) matching seasonal vaccine supply with seasonal consumer demand, thereby significantly facilitating the timely and economical production, distribution, and/or administration of seasonal vaccine.

Thus, the inventive subject matter relates to an automated, consumer-driven, vaccine reservation system configured to substantially guarantee a vaccine consumer access to a dose of vaccine, comprising the following elements, operably connected:

at least one electronic database configured to receive and store vaccine reservation information;

at least one electronic computer system having at least one storage medium configured for hosting said electronic database;

at least one human interface for enabling said vaccine reservation information to be communicated between said electronic database system and a system user; and

client software residing on said at least one storage medium providing an interface to said at least one database and operable for processing vaccine reservation information,

said client software operable for enabling a user desiring to reserve a dose of vaccine to reserve at least one dose of vaccine on a pre-production basis,

said client software operable for processing financial compensation for said reserved vaccine, and

said client software operable for providing vaccine reservation information to a system user for use by at least one vaccine producer for determining seasonal vaccine production quantity.

The inventive subject matter further relates to an automated, consumer-driven, vaccine reservation system configured to substantially guarantee a vaccine consumer access to a dose of vaccine, comprising the following elements, operably connected:

at least one electronic database configured to receive and store vaccine reservation information;

at least one electronic computer system having at least one storage medium configured for hosting said electronic database;

at least one human interface for enabling said vaccine reservation information to be communicated between said electronic database system and a system user; and

client software residing on said at least one storage medium providing an interface to said at least one database and operable for processing vaccine reservation information,

said client software operable for enabling a user desiring to reserve a dose of vaccine to reserve at least one dose of vaccine on a pre-production basis,

said client software operable for processing financial compensation for said reserved vaccine,

said client software operable for enabling a user to reserve more than one dose of a vaccine, and

said software operable for enabling said user to donate an unused dose of vaccine so reserved.

The inventive subject matter further relates to a method for substantially guaranteeing an individual vaccine consumer access to at least one dose of vaccine and providing at least one vaccine producer with data for determining seasonal vaccine production quantity using a automated, consumer-driven, vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine; and

accepting or securing financial compensation for said at least one dose of vaccine so reserved,

whereby said vaccine reservation system enables said vaccine consumer to reserve at least one dose of vaccine, to substantially guarantee said consumer access to the reserved vaccine and to provide at least one vaccine producer with access to data for determining seasonal vaccine production quantity.

The inventive subject matter additionally relates to a method for substantially guaranteeing an individual vaccine consumer access to at least one dose of vaccine and providing at least one vaccine producer with data for determining seasonal vaccine production quantity using a automated, consumer-driven, vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve more than one dose of vaccine;

accepting or securing financial compensation for said more than one dose of vaccine so reserved; and

enabling said user to donate an unused dose of vaccine so reserved.

Further, the inventive subject matter relates to a method for matching seasonal vaccine supply with seasonal vaccine demand using a consumer-driven reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

accepting or securing financial compensation for said at least one dose of vaccine so reserved; and

providing at least one vaccine producer with access to data for determining seasonal vaccine production quantity.

Additionally, the inventive subject matter further relates to a method for reducing financial risk to vaccine provider using consumer-driven vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

securing a guaranty of at least partial payment from said vaccine consumer for said at least one dose of vaccine so reserved; and

securing a commitment from said vaccine consumer for a recurring subscription to multiple vaccines.

Further, the inventive subject matter further relates to a method for reducing a pathogenic infection rate using a consumer-driven vaccine reservation system operable to reserve a dose of vaccine, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

securing a guaranty of at least partial payment from said vaccine consumer for said at least one dose of vaccine so reserved; and

securing agreement of a vaccine consumer to limit the liability of a vaccine provider related to a vaccine product.

The inventive subject matter also relates to a method for reducing a pathogenic infection rate using a consumer-driven vaccine reservation system operable to reserve a dose of vaccine, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

providing notice of an existing, emerging, or forecast pathogenic threat to a vaccine consumer to assist in selecting a vaccine for reservation; and

providing a substantially automated system for selecting and ordering a dose of vaccine.

### BRIEF DESCRIPTION OF THE DRAWINGS

FIG. 1 is a schematic diagram of the primary elements of a typical, substantially automated, principally consumer-driven, generally pre-production, seasonal vaccine reservation system.

FIG. 2 is a schematic process flow chart of a typical method of the present invention for permitting consumers to substantially guarantee access to a dose of vaccine by reserving one or more doses of seasonal vaccine using a substantially automated, principally consumer-driven, generally pre-production, seasonal vaccine reservation system.

FIG. 3 is a schematic process flow chart of a typical (but optional) method of the present invention for processing compensation for one or more reserved doses of vaccine, thereby reducing the financial risk to a producer of vaccine by using a substantially automated, principally consumer-driven, generally pre-production, seasonal vaccine reservation system.

FIG. 4 is a schematic process flow chart of a typical (but optional) method of the present invention for accurately matching seasonal vaccine supply with seasonal consumer demand using a substantially automated, principally consumer-driven, generally pre-production, seasonal vaccine reservation system.

FIG. 5 is a schematic process flow chart of a typical (but optional) method of the present invention for facilitating distribution and/or timely administration of seasonal vaccine using a substantially automated, principally consumer-driven, generally pre-production, seasonal vaccine reservation system.

FIG. 6 is a schematic process flow chart of a typical (but optional) method of the present invention for directing the consumer regarding the general availability of vaccine for administration (or a specific appointment for vaccine administration) by using a substantially automated, principally consumer-driven, generally pre-production, seasonal vaccine reservation system.

FIG. 7 is a schematic process flow chart of a typical (but optional) method of the present invention for evaluating the consumer's response to the vaccine using a substantially automated, principally consumer-driven, generally pre-production, seasonal vaccine reservation system.

### DETAILED DESCRIPTION OF THE INVENTIVE SUBJECT MATTER

The present invention, in its preferred embodiments, is a substantially automated, consumer-driven, pre-production, vaccine reservation system for facilitating the efficient (e.g., accurate, economical, and timely) production, distribution, administration, and/or post-administration evaluation of health-critical, long-production-lead-time vaccines such as, for example, seasonal influenza or “flu” virus vaccines. The implementation of such a consumer-driven vaccine reservation system provides a highly effective system and/or method for substantially ensuring or guaranteeing that consumer demand for seasonal vaccine can be fully and consistently met, but without subjecting the producers of vaccine and/or other cognizant parties associated with the healthcare industry to undue financial risk.

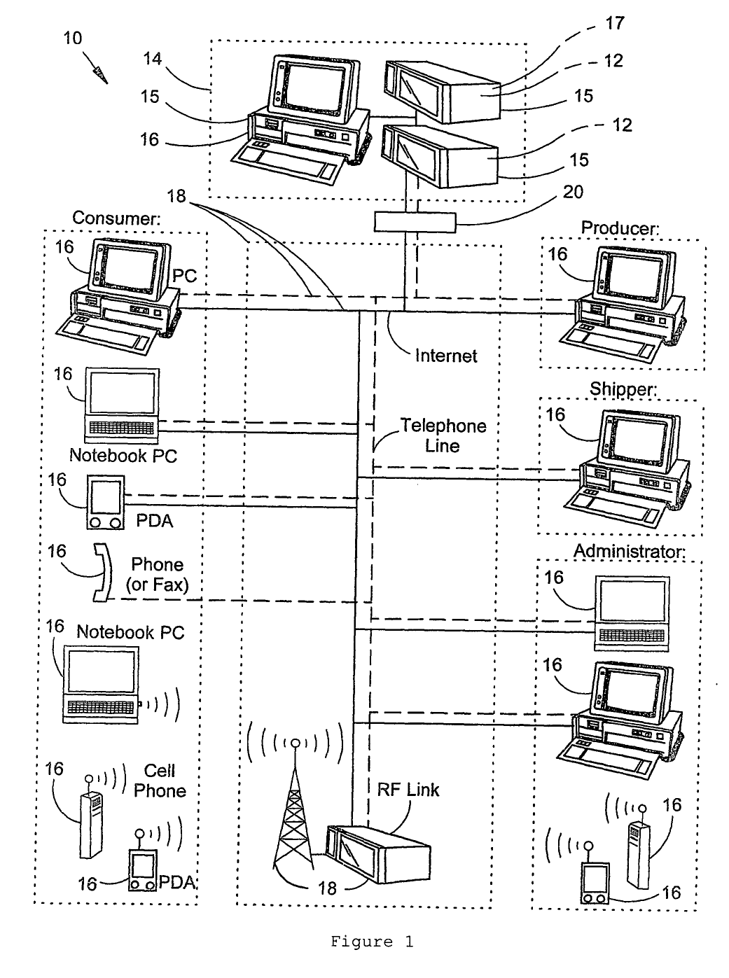

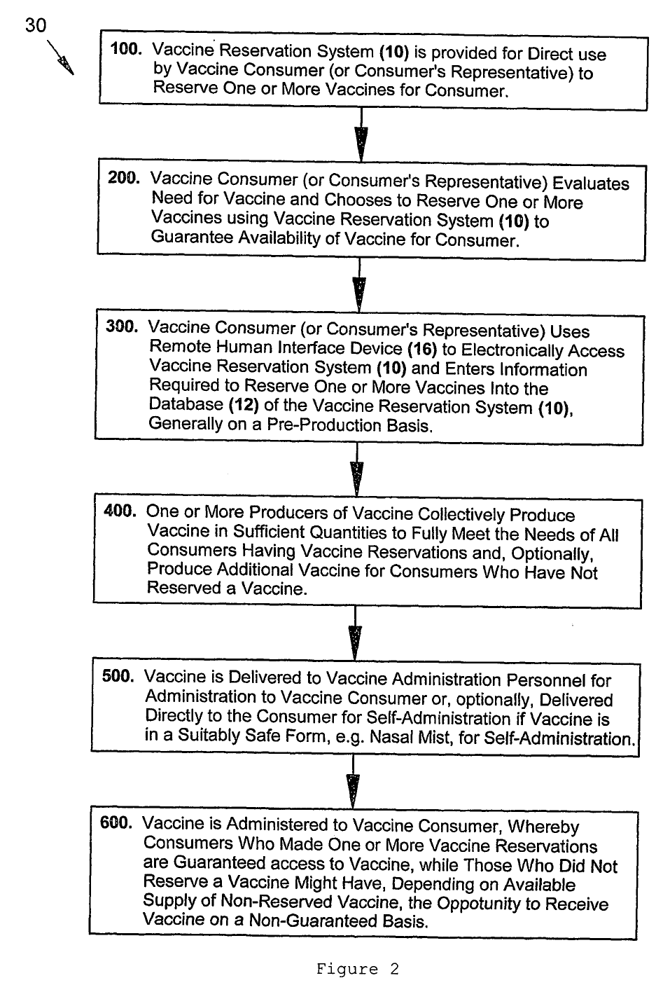

Briefly, FIG. 1 depicts the principal physical elements comprising such a consumer-driven vaccine reservation system, but also shows various optional and/or redundant elements. FIGS. 2-7 depict various unique methods for facilitating the accurate, economical, and/or timely production, distribution, administration, and/or post-administration evaluation of seasonal vaccine (or other health-critical, long-production-lead-time medical products) using a substantially automated, typically consumer-driven, generally pre-production, seasonal vaccine reservation system.

Regarding terminology, note that “substantially automated” indicates that the vaccine reservation system significantly utilizes one or more electronic computing devices, operable logical computer algorithms (and/or client software interfaces), and/or other automation tools to provide and/or perform a substantial portion of the system and/or the methods or functions thereby performed. Additionally, “consumer-driven”, as used herein, indicates that the consumer (or a representative thereof) has primary responsibility for making a vaccine reservation using the vaccine reservation system of the present invention, whereby such reservations made by the consumer will typically, but not necessarily, be used as an aid to significantly or substantially establish or “drive” production quantities. Further, “pre-production” indicates that reservations may be substantially made prior to the commencement of production of vaccine, whereby such pre-production reservations have the ability to affect or influence the quantities of vaccine which will be produced.

It is noted that FIGS. 1-7, in concert with the description of the invention as presented herein, provide several specific embodiments (or parts thereof) of the present invention; however, it is emphasized that the invention is not limited to the specific examples of the physical systems and/or the improved methods as depicted or described herein. More specifically, the present invention provides numerous alternate configurations of these systems and/or methods, including various combinations, simplifications, and/or other modifications thereof, without departing from the nature of the invention. Additionally, although the invention disclosed herein is principally described as various means and/or improved methods for facilitating the production, distribution, and/or administration of seasonal vaccine, it is noted that the present invention is also highly applicable to other pharmacological agents, non-limiting examples of which may include anti-biological warfare agents and/or other newly developed and/or limited-availability agents.

### Typical Advantages Over Prior Art

The present invention, in one or more of its preferred embodiments, is typically superior to the related art (i.e., the current operational practices within the healthcare industry for producing, distributing, and/or administering seasonal vaccine) in at least eight significant respects:

First, the present invention, in its preferred embodiments, is superior to the related art in that it is operable to substantially ensure or guarantee access to vaccine for all consumers who choose to reserve a vaccine prior to production. In contrast, current medical operational practices do not provide such a reservation system, thereby exposing the health care consumer to unnecessary risk of infection and possibly death by providing no guaranteed access to vaccine. Further, there is no clear suggestion within open literature (or otherwise within the healthcare industry) that the healthcare industry has contemplated the improved systems and/or methods as proposed herein, or the benefits thereof.

Second, the present invention, in one or more of its embodiments, is superior to the related art in that it provides an extremely accurate method for matching seasonal supply to seasonal demand, thereby significantly mitigating both the risk of underproduction (i.e., shortages) of vaccine, as well as the risk of expensive overproduction. In contrast, as noted above, prior art fails to provide any such provision for accurately matching seasonal vaccine supply and demand, often leading to significant imbalances between vaccine supply and demand, thereby causing severe health and/or economic consequences.

Third, the present invention, in one or more of its embodiments, is superior to the related art in that it ensures the producers of vaccine will be appropriately compensated for substantially all vaccines reserved by the consumer on a pre-production basis, thereby significantly mitigating the financial risks to the producers of vaccine. In contrast, the related art provides no means for capturing or securing production costs (or a proxy thereof) from the consumer (and/or the consumer's representative or agent) prior to vaccine delivery and administration, thereby subjecting such producers and/or their financial underwriters (including governmental health agencies) to significant financial risk.

Fourth, the present invention, in one or more of its embodiments, is superior to the related art in that it optionally provides the producer of vaccine with geographical information regarding the consumers who have reserved a vaccine, thereby facilitating accurate and timely geographical distribution of vaccine. Again, related art contains no such provisions, thus, requiring healthcare industry professionals to forecast need by geographic region, thereby resulting in the possibility (and real occurrences) of local shortages and/or local oversupply, regardless of the overall balance between supply and demand.

Fifth, the present invention, in one or more of its embodiments, is superior to the related art in that it prompts and/or incentivizes consumers to actually get vaccinated by (1) providing readily accessible optional means for establishing a specific appointment (e.g., date, time, and/or location) for vaccination, (2) providing an optional means for automatically informing consumers of the general availability of vaccine for administration and/or of a specific appointment, thereby reducing lack of vaccination due to procrastination, forgetfulness, distraction, and the like, and/or (3) providing an optional means for incentivizing vaccine consumers, such as by providing a discounted or reduced fee for vaccination if the vaccine is reserved and/or paid prior to the start of production. Other than by general medical appointments or office visits, prior art provides no readily accessible means for scheduling or incentivizing a simple vaccination, many of which are given outside the medical office (for example, in a community school gymnasium, a local grocery store or pharmacy, and the like), and therefore generally cannot effectively utilize the existing medical infrastructure for appointments.

Sixth, the present invention, in one or more of its embodiments, is superior to the related art in that it provides an effective means for post-vaccination evaluation of one or more vaccines or other pharmacological agents.

Seventh, the present invention, in one or more of its embodiments, is superior to the related art in that it provides an effective means for allowing individuals or other benefactors to charitably gift one or more vaccines to those in need of vaccine, but having insufficient financial means. In addition, the present invention is superior to the related art in that it provides an effective means for registering individuals in need of and/or optionally authorized to receive one or more vaccines via charitable gift.

Eighth, the present invention, in one or more of its embodiments, is superior to the related art in that it provides an effective means for educating the vaccine consumer regarding (1) the general and/or specific pathogenic risks or (2) vaccines which might be available to mitigate or eliminate such risks. In addition, the present invention is superior in that it provides the vaccine consumer with an effective means for planning or managing personal vaccinations.

As one reads subsequent sections of this document, it will be apparent that the present invention is also superior to the related art in a variety of other ways optionally including, as non-limiting examples: providing improved means and/or methods for reporting and tracking the effectiveness of vaccine in preventing illness, adverse reactions to vaccine, and the like.

### Specific Objects and Advantages of the Present Invention:

Accordingly, it is a principal object of the present invention to provide a substantially automated means (comprising a physical system and/or one or more operational methods) for permitting vaccine consumers to reserve one or more seasonal vaccines, generally, but not necessarily, on a pre-production basis (such as may be reserved by using an internet-connected electronic computer system hosting a suitable electronic reservation database), thereby substantially ensuring or guaranteeing individual consumers access to one or more health-sustaining seasonal vaccines. Additionally, another closely related object of the present invention is to provide a substantially automated means for permitting the consumer to select and reserve a particular type (or types) of vaccine including, for example, the method of vaccine administration (e.g., injection, nasal mist, oral, and the like), the particular strain (or strains) of pathogen (or pathogens) the consumer wishes to be protected against via one or more vaccines (optionally including the ability to specify one or more custom-produced vaccines for a particular individual or group), and/or the method of vaccine production (e.g., pathogen incubation within the egg of a chicken or, alternatively, some non-allergenic method of vaccine production).

A second object of the present invention is to optionally provide a substantially automated, typically consumer-driven means (comprising a physical system and/or one or more operational methods) for matching seasonal vaccine supply with seasonal consumer demand, whereby vaccine production quantities are, at least in part, substantially automatically precisely determined by summing the number of vaccines reserved by the consumer and/or the consumer's representative (such as may be contained within a suitable electronic reservation database hosted on an optionally internet-connected, electronic computer system), thereby simultaneously reducing both the health risk to the consumer associated with underproduction (i.e., shortages) of vaccine, and the financial risk to the producer associated with wasteful overproduction of vaccine.

A third object of the present invention is to optionally provide a substantially automated, typically consumer-driven means (comprising a physical system and/or one or more operational methods) for further reducing the financial risk to producers of vaccine and/or other financially interested parties, such as by providing a substantially automated system and/or method for processing compensation (e.g., collecting payment), either in full or in part, for such reserved vaccines prior to the commencement of vaccine production including, for example, the use of an internet-based or “on-line” electronic store, (or any other well-known means for accepting payment from remote purchasers), and/or a substantially automated electronic computer-based billing system for billing the consumer or some third party, such as an insurance company, a government health program (e.g., Medicare/Medicaid), and the like.

A fourth object of the present invention is to optionally provide a substantially automated, consumer-driven means (comprising a physical system and/or one or more operational methods) for facilitating timely distribution and/or administration of seasonal vaccine, such as by querying a suitable electronic vaccine reservation database containing the consumer's addresses and/or other relevant geographic or demographic data, thereby enabling the producers to accurately distribute vaccine (accounting for both type and quantity of vaccine) to the appropriate geographic regions, but also enabling regional healthcare providers to determine the required size of the local vaccine administration workforce and/or facilities based on such electronic queries of the vaccine reservation database.

A fifth object of the present invention is to optionally provide a substantially automated, consumer-driven means (comprising a physical system and/or one or more operational methods) for directing the consumer regarding the general availability of vaccine for administration within consumer's locality and/or for providing a reminder to the consumer (and/or the consumer's representative) regarding a specific appointment (e.g., date, time, location) for vaccine administration, thereby significantly enhancing the probability that the consumer will actually present himself or herself for vaccination.

A sixth object of the present invention is to optionally provide a substantially automated, consumer-driven means (comprising a physical system and/or one or more operational methods) for evaluating the consumer's response to the vaccine, both in terms of the efficacy of the vaccine in preventing illness, and/or the consumer's adverse reaction to the vaccine, if any, thereby providing an effective means for improved information feedback from the consumer to the healthcare industry.

A seventh object of the present invention is to optionally provide a substantially automated, consumer-driven means (comprising a physical system and/or one or more operational methods) for allowing individuals or other benefactors to charitably gift one or more vaccines to those in need of vaccine, but having insufficient financial means. A closely related object of the present invention is to optionally provide an effective means (comprising a physical system and/or one or more operational methods) for registering individuals in need of and/or optionally authorized to receive one or more vaccines via charitable gift.

An eight object of the present invention is to optionally provide a substantially automated, consumer-driven means (comprising a physical system and/or one or more operational methods) for educating the vaccine consumer regarding (1) the general and/or specific pathogenic risks or (2) the vaccines which might be available to mitigate or eliminate such risks. A closely related object of the present invention is to optionally provide the vaccine consumer (or other entity) with an effective means (comprising a physical system and/or one or more operational methods) for planning and/or managing personal vaccinations over time.

These and other objects of the present invention are readily apparent upon further review of the following specification and drawings. However, it is emphasized that any particular embodiment or manifestation of the present invention need not perform all such functions or otherwise meet all such objects of the present invention. In addition, it is emphasized that the invention is not intended to be limited to the specific examples as shown or described herein.

Regarding terminology, note that the use of the parenthetical expression “(comprising a physical system and/or one or more operational methods)” in the preceding paragraphs of this section of the application is specifically intended to define (or equate) the associated “means/function” language in each of the preceding paragraphs as one or more physical elements of an electronic computing system and/or one or more electronic computing algorithms implemented therein, each of which is operable to perform at least a portion of the function indicated by the associated means language.

Thus, the inventive subject matter relates to an automated, consumer-driven, vaccine reservation system configured to substantially guarantee a vaccine consumer access to a dose of vaccine, comprising the following elements, operably connected:

at least one electronic database configured to receive and store vaccine reservation information;

at least one electronic computer system having at least one storage medium configured for hosting said electronic database;

at least one human interface for enabling said vaccine reservation information to be communicated between said electronic database system and a system user; and

client software residing on said at least one storage medium providing an interface to said at least one database and operable for processing vaccine reservation information,

said client software operable for enabling a user desiring to reserve a dose of vaccine to reserve at least one dose of vaccine on a pre-production basis,

said client software operable for processing financial compensation for said at least one dose of vaccine so reserved, and

said client software operable for providing vaccine reservation information to a system user for use by at least one vaccine producer for determining seasonal vaccine production quantity.

In one aspect of the inventive subject matter, said software is operable to provide access to a user to said at least one database.

In another aspect of the inventive subject matter, said financial compensation comprises payment in full for said reserved dose.

In a preferred embodiment, said financial compensation comprises a deposit for said reserved dose.

In another preferred embodiment, said software processes a refundable deposit after a financial commitment is made for payment for said reserved dose.

In a further aspect of the inventive subject matter, said software is operable for processing compensation to a user for promoting vaccination.

In an alternate aspect of the inventive subject matter, said software is operable for providing for establishment of a financial trust for processing financial compensation for future vaccine reservations.

In yet another aspect of the inventive subject matter, said software is operable for providing for escrowing payments, deposits, or combinations thereof.

In a further aspect of the inventive subject matter, said software is operable for providing for encouraging vaccination participation by offering to said user one or more of the following financial incentives:

reduced cost for orders made on a pre-production basis;

reduced cost for orders made at time of current vaccination for a subsequent vaccination;

reduced cost for orders by a repeat consumer;

reduced cost for orders made with a liability waiver signed by consumer or consumer's representative;

reduced cost for holders of equity in vaccine reservation system enterprise;

offer of equity share in vaccine reservation system enterprise for repeat consumers;

reduced cost for consumer vaccine administration appointment attended as scheduled;

reduced cost for consumer vaccine administration appointment scheduled for designated off-peak time;

reduced cost for vaccine donors;

reduced cost for a group reserved and administered together at one time and place;

reduced cost for appearance at scheduled appointment with all required documents preprinted and completed; and

reduced cost for customer use of paper-less documentation to reduce cost to providers.

In a preferred embodiment, said software is operable for enabling a user to reserve more than one dose of a vaccine.

In a more preferred embodiment, said more than one dose of vaccine is reserved from a plurality of vaccine sources.

In a further preferred embodiment, said software is operable for enabling said user to donate an unused dose of vaccine so reserved.

In a further aspect of the inventive subject matter, said software operable for summing the number of reserved doses of vaccine in said electronic database, whereby the sum of reserved doses of vaccine is available to said at least one vaccine provider.

In a preferred embodiment, said number of reserved doses of vaccine is available via an active link to said database, said link operable to provide information substantially in real time.

In another alternate aspect of the inventive subject matter, said system further comprises medical records of a vaccine consumer stored on at least one database, said software operable for screening said records, and said software operable for providing notice to said user that a vaccine is medically appropriate or inappropriate for administration to said vaccine consumer.

In a preferred embodiment, said medical records are input manually by a user.

In a more preferred embodiment, said software provides an interface to a vaccine consumer's medical records on an as-needed basis.

In a most preferred embodiment, said software provides an interface to a vaccine consumer's medical records on a substantially real time basis.

In another aspect of the inventive subject matter, said software evaluates information comprising vaccine delivery method, cost, lead time, side effects, or a combination thereof, and recommends to said user the selection of one or more specific vaccines for a patient.

In a preferred embodiment, said software automatically reserves one or more doses of vaccine based on said information evaluation.

In a more preferred embodiment, said one or more doses of vaccine are reserved from a plurality of vaccine sources.

In another aspect, said one or more doses of vaccine comprise a plurality of doses of vaccine administered over a period of time.

In yet another aspect of the inventive subject matter, said vaccine reservation system further comprises an interface to information relating to an emerging pathogenic threat, said software is operable for enabling a user to pre-authorize said system to authorize the production of a vaccine for said emerging pathogenic threat upon satisfaction of one or more conditions, and said software is operable for analyzing said information for satisfaction of said one or more conditions and automatically authorizing said production of a vaccine.

In another aspect of the inventive subject matter, said vaccine consumer is a dependent person and said software provides an interface for a legal representative of said dependent person to authorize reservation of a dose of vaccine for said dependent person, processing financial compensation for said reserved vaccine, or both.

In a further aspect of the inventive subject matter, said software is operable for aggregating the reservation information of individual consumers in order to reduce the unit cost of vaccine, the costs of administration, or both.

In an alternate aspect of the inventive subject matter, said software assigns access priority to a dose of vaccine in the event of a vaccine shortage.

In a preferred embodiment, said assignment is made on the basis of random chance, or on factors selected from the group comprising consumer age, health status, susceptibility to pathogen transmissibility or virulence, or a combination thereof.

In yet another aspect of the inventive subject matter, said software is operable for managing inventory of a dose of vaccine, enabling re-ordering of a dose of vaccine, or both.

In a further aspect of the inventive subject matter, said software is operable for parsing said electronic database to establish the quantities of a type of vaccine to be distributed to a particular location.

In a preferred embodiment, said software is additionally operable for parsing said electronic database to determine vaccine distribution at a particular time.

In another preferred embodiment, said software is operable for enabling packaging one or more doses of vaccine for shipping to a particular location.

In a further preferred embodiment, said software is operable for managing storage, dispensing, or a combination thereof, of a reserved dose of vaccine to a vaccine consumer.

In yet another preferred embodiment, said software is operable for managing inventory of a dose of vaccine for enabling distribution or redistribution of a dose of vaccine.

In a further preferred embodiment, said software is operable for tracking the location of a dose of vaccine.

In an additional preferred embodiment, said software is operable for tracking the time since production of a dose of vaccine.

In another preferred embodiment, said software is operable for tracking the environmental conditions experienced by a dose of vaccine after production.

In another aspect of the inventive subject matter, said vaccine reservation system additionally comprises a computer-readable tag affixed to a dose of vaccine; and an electronic reader configured to read said tag.

In an alternate aspect of the inventive subject matter, said software is operable for communicating to said user reserving a dose of vaccine the availability of vaccine for administration.

In a preferred embodiment, said software is operable for enabling said user reserving a dose of vaccine to establish a specific appointment for the administration of said vaccine.

In another preferred embodiment, said software is operable for managing vaccine administration personnel to meet a scheduled appointment.

In an alternate aspect of the inventive subject matter, said software is operable for enabling verification of compliance with a vaccination protocol.

In a preferred embodiment, said software is operable for enabling reporting of said verification to an appropriate recipient of said information, comprising government agencies, physicians, health plans, schools, employers, or a combination thereof.

In another aspect of the inventive subject matter, said software is operable for enabling acquiring and reporting consumer response data relating to said vaccine.

In a preferred embodiment, said data comprises physical responses selected from the group comprising efficacy, adverse effects, side effects, adverse events, or a combination thereof.

In another preferred embodiment, said reporting is made to vaccine producers, vaccine providers, government agencies, health plans, physicians, consumer organizations, system users, consumers, or a combination thereof.

In a further preferred embodiment, said data comprises consumer evaluation of vaccination services, said evaluation data selected from the group consisting of ratings and rankings to enable vaccine consumers to discriminate between providers.

In a further aspect of the inventive subject matter, said software is operable for enabling a donee to donate one or more doses of vaccine to recipients in need of vaccine.

In a preferred embodiment, said software is operable for providing for charitable fundraising activities within said vaccine reservation system.

In a more preferred embodiment, said charitable fundraising activities comprise soliciting and receiving contributions, organizing a fundraising event, announcing a fundraising event, soliciting and receiving grants, and soliciting and receiving matching funds.

In yet another aspect of the inventive subject matter, said software is operable for reviewing potential recipients for authorization to receive one or more doses of vaccine via charitable gift.

In a preferred embodiment, said software is operable for registering recipients authorized to receive one or more doses of vaccine via charitable gift.

In another preferred embodiment, said software is operable for providing for distributing a dose of vaccine to recipients registered to receive vaccine(s) via charitable gift.

In a more preferred embodiment, said charitable gift dose of vaccine is a redistributed excess or surplus dose.

In a further aspect of the inventive subject matter, said software is operable for evaluating an existing, emerging, or forecast pathogenic threat to a vaccine consumer, and said software is operable for providing notice of said threat to a system user to assist in selecting a vaccine for reservation.

In a preferred embodiment, said software is operable for tracking consumer travel, and wherein said threat relates to a risk of pathogenic exposure arising from completed travel by a vaccine consumer.

In yet another aspect of the inventive subject matter, said software is operable for providing educational materials to a system user.

In a preferred embodiment, said educational materials comprise information relating to pathogenic threats, doses of vaccine, the vaccination process, complementary methods for infection treatment or avoidance, seasonal health education, or a combination thereof.

In an alternate aspect of the inventive subject matter, said software is operable for managing future vaccinations.

In a preferred embodiment, said software is operable for screening records of a vaccine consumer, and said software is operable for providing notice to a user that a vaccine is appropriate or inappropriate for administration to said vaccine consumer.

In another preferred embodiment, said software is operable for providing a reminder to a user of the need for a periodic vaccination.

In a more preferred embodiment, said periodic vaccination is selected from the group comprising a multiple-injection vaccination course, a seasonal vaccination, a school required vaccination, a work required vaccination, a travel required vaccination, a pediatric vaccination course, a periodic booster vaccination, or combinations thereof.

In a further preferred embodiment, said software is operable for evaluating an existing, emerging, or forecast pathogenic threat to a vaccine consumer, and said software is operable for providing notice of said threat to a user.

In a preferred embodiment, said threat relates to intended consumer travel.

In another aspect of the inventive subject matter, said software is operable for monitoring a regional vaccination rate and reporting high-risk regions.

In an alternate aspect of the inventive subject matter, said software is operable for securing agreement of a vaccine consumer to limit the liability of a vaccine provider for a vaccine product.

In a further aspect of the inventive subject matter, said software is operable for enabling multi-language operability of said system.

The inventive subject matter further relates to an automated, consumer-driven, vaccine reservation system configured to substantially guarantee a vaccine consumer access to a dose of vaccine, comprising the following elements, operably connected:

at least one electronic database configured to receive and store vaccine reservation information;

at least one electronic computer system having at least one storage medium configured for hosting said electronic database;

at least one human interface for enabling said vaccine reservation information to be communicated between said electronic database system and a system user; and

client software residing on said at least one storage medium providing an interface to said at least one database and operable for processing vaccine reservation information,

said client software operable for enabling a user desiring to reserve a dose of vaccine to reserve at least one dose of vaccine on a pre-production basis,

said client software operable for processing financial compensation for said reserved vaccine,

said client software operable for enabling a user to reserve more than one dose of a vaccine, and

said software operable for enabling said user to donate an unused dose of vaccine so reserved.

In a preferred embodiment, said more than one dose of vaccine is reserved from a plurality of vaccine sources.

The inventive subject matter further relates to a method for substantially guaranteeing an individual vaccine consumer access to at least one dose of vaccine and providing at least one vaccine producer with data for determining seasonal vaccine production quantity using a automated, consumer-driven, vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine; and

accepting or securing financial compensation for said at least one dose of vaccine so reserved,

whereby said vaccine reservation system enables said vaccine consumer to reserve at least one dose of vaccine, to substantially guarantee said consumer access to the reserved vaccine and to provide at least one vaccine producer with access to data for determining seasonal vaccine production quantity.

In one aspect of the inventive subject matter, said software is operable to provide access to said at least one database to a system user.

In another aspect of the inventive subject matter, said financial compensation comprises payment in full for said reserved dose.

In a preferred embodiment, said financial compensation comprises a deposit for said reserved dose.

In another preferred embodiment, said software processes a refundable deposit after a financial commitment is made for payment for said reserved dose.

In a further aspect of the inventive subject matter, said method further comprises the step of processing compensation to a user for promoting vaccination.

In an alternate aspect of the inventive subject matter, said method further comprises the step of providing for establishment of a financial trust for processing financial compensation for future vaccine reservations.

In yet another aspect of the inventive subject matter, said method further comprises the step of providing for escrowing payments, deposits, or combinations thereof.

In a further aspect of the inventive subject matter, said method further comprises the step of providing for encouraging vaccination participation by offering to said user one or more of the following financial incentives:

reduced cost for orders made on a pre-production basis;

reduced cost for orders made at time of current vaccination for a subsequent vaccination;

reduced cost for orders by a repeat consumer;

reduced cost for orders made with a liability waiver signed by consumer or consumer's representative;

reduced cost for holders of equity in a vaccine reservation system enterprise executing the present method;

offer of equity share to repeat consumers of a vaccine reservation system enterprise executing the present method;

reduced cost for consumer vaccine administration appointment attended as scheduled;

reduced cost for consumer vaccine administration appointment scheduled for designated off-peak time;

reduced cost for vaccine donors;

reduced cost for a group reserved and administered together at one time and place;

reduced cost for appearance at scheduled appointment with all required documents preprinted and completed; and

reduced cost for customer use of paper-less documentation to reduce cost to providers.

In a preferred embodiment, said method further comprises the step of enabling a user to reserve more than one dose of a vaccine.

In a more preferred embodiment, said one or more doses of vaccine comprise a plurality of doses of vaccine administered over a period of time.

In a further preferred embodiment, said more than one dose of vaccine is reserved from a plurality of vaccine sources.

In yet a further preferred embodiment, said method further comprises the step of enabling said user to donate an unused dose of vaccine so reserved.

In a further aspect of the inventive subject matter, said method further comprises the step of summing the number of reserved doses of vaccine in said electronic database, whereby the sum of reserved doses of vaccine is available to said at least one vaccine provider.

In a preferred embodiment, said number of reserved doses of vaccine is available via an active link to said database, said link operable to provide information substantially in real time.

In another alternate aspect of the inventive subject matter, said method further comprises the steps of:

storing medical records of a vaccine consumer on at least one database,

screening said records, and

providing notice to said user that a vaccine is medically appropriate or inappropriate for administration to said vaccine consumer.

In a preferred embodiment, said medical records are input manually by a user.

In a more preferred embodiment, said software provides an interface to a vaccine consumer's medical records on an as-needed basis.

In a most preferred embodiment, said software provides an interface to a vaccine consumer's medical records on a substantially real time basis.

In another aspect of the inventive subject matter, said method further comprises the steps of evaluating information comprising vaccine delivery method, cost, lead time, side effects, or a combination thereof, and recommending to said user the selection of one or more specific vaccines for a patient.

In a preferred embodiment, said method further comprises the step of automatically reserving one or more doses of vaccine based on said information evaluation.

In another aspect, said one or more doses of vaccine comprise a plurality of doses of vaccine administered over a period of time.

In a preferred embodiment, said one or more doses of vaccine are reserved from a plurality of vaccine sources.

In yet another aspect of the inventive subject matter, said method further comprises the steps of:

providing an interface to information relating to an emerging pathogenic threat,

enabling a user to pre-authorize said system to authorize the production of a vaccine for said emerging pathogenic threat upon satisfaction of one or more conditions,

analyzing said information for satisfaction of said one or more conditions, and

automatically authorizing said production of a vaccine upon satisfaction of said one or more conditions.

In another aspect of the inventive subject matter, said vaccine consumer is a dependent person and said software provides an interface for a legal representative of said dependent person to authorize reservation of a dose of vaccine for said dependent person, processing financial compensation for said reserved vaccine, or both.

In a further aspect of the inventive subject matter, said method further comprises the step of aggregating the reservation information of individual consumers in order to reduce the unit cost of vaccine, the costs of administration, or both.

In an alternate aspect of the inventive subject matter, said method further comprises the step of assigning access priority to a dose of vaccine in the event of a vaccine shortage.

In a preferred embodiment, said assignment is made on the basis of random chance, or on factors selected from the group comprising consumer age, health status, susceptibility to pathogen transmissibility or virulence, or a combination thereof.

In yet another aspect of the inventive subject matter, said method further comprises the step of managing inventory of a dose of vaccine, enabling re-ordering of a dose of vaccine, or both.

In a further aspect of the inventive subject matter, said method further comprises the step of parsing said electronic database to establish the quantities of a type of vaccine to be distributed to a particular location.

In a preferred embodiment, said method further comprises the step of parsing said electronic database to determine vaccine distribution at a particular time.

In another preferred embodiment, said method further comprises the step of enabling packaging of one or more doses of vaccine for shipping to a particular location.

In a further preferred embodiment, said method further comprises the step of managing storage of vaccine, dispensing a reserved dose of vaccine to a vaccine consumer, or a combination thereof.

In yet another preferred embodiment, said method further comprises the step of managing inventory of a dose of vaccine for enabling distribution or redistribution of a dose of vaccine.

In a further preferred embodiment, said method further comprises the step of tracking the location of a dose of vaccine.

In an additional preferred embodiment, said method further comprises the step of tracking the time since production of a dose of vaccine.

In another preferred embodiment, said method further comprises the step of tracking the environmental conditions experienced after production by a dose of vaccine.

In another aspect of the inventive subject matter, said step of managing inventory further comprises the use of a computer-readable tag affixed to a dose of vaccine and an electronic reader configured to read said tag.

In an alternate aspect of the inventive subject matter, said method further comprises the step of communicating to said user reserving a dose of vaccine the availability of vaccine for administration.

In a preferred embodiment, said method further comprises the step of enabling said user reserving a dose of vaccine to establish a specific appointment for the administration of said vaccine.

In another preferred embodiment, said method further comprises the step of managing vaccine administration personnel to meet a scheduled appointment.

In an alternate aspect of the inventive subject matter, said method further comprises the step of enabling verification of compliance with a vaccination protocol.

In a preferred embodiment, said method further comprises the step of enabling reporting of said verification to an appropriate recipient of said information, comprising government agencies, physicians, health plans, schools, employers, or a combination thereof.

In another aspect of the inventive subject matter, said method further comprises the step of enabling acquiring and reporting consumer response data relating to said vaccine.

In a preferred embodiment, said data comprises physical responses selected from the group comprising efficacy, adverse effects, side effects, adverse events, or a combination thereof.

In another preferred embodiment, said reporting is made to vaccine producers, vaccine providers, government agencies, health plans, physicians, consumer organizations, system users, consumers, or a combination thereof.

In a further preferred embodiment, said data comprises consumer evaluation of vaccination services, said evaluation data selected from the group consisting of ratings and rankings to enable vaccine consumers to discriminate between providers.

In a further aspect of the inventive subject matter, said method further comprises the step of enabling a donee to donate one or more doses of vaccine to recipients in need of vaccine.

In a preferred embodiment, said method further comprises the step of providing for charitable fundraising activities.

In a more preferred embodiment, said charitable fundraising activities comprise soliciting and receiving contributions, organizing a fundraising event, announcing a fundraising event, soliciting and receiving grants, soliciting and receiving matching funds, or combinations thereof.

In yet another aspect of the inventive subject matter, said method further comprises the step of reviewing potential recipients for authorization to receive one or more doses of vaccine via charitable gift.

In a preferred embodiment, said method further comprises the step of registering recipients authorized to receive one or more doses of vaccine via charitable gift.

In another preferred embodiment, said method further comprises the step of providing for distributing a dose of vaccine to recipients registered to receive vaccine(s) via charitable gift.

In a more preferred embodiment, said charitable gift dose of vaccine is a redistributed excess or surplus dose.

In a further aspect of the inventive subject matter, said method further comprises the step of evaluating an existing, emerging, or forecast pathogenic threat to a vaccine consumer, and providing notice of said threat to a system user to assist in selecting a vaccine for reservation.

In a preferred embodiment, said method further comprises the step of tracking consumer travel, and wherein said threat relates to a risk of pathogenic exposure arising from completed travel by a vaccine consumer.

In yet another aspect of the inventive subject matter, said method further comprises the step of providing educational materials to a system user.

In a preferred embodiment, said educational materials comprise information relating to pathogenic threats, doses of vaccine, the vaccination process, complementary methods for infection treatment or avoidance, seasonal health education, or a combination thereof.

In an alternate aspect of the inventive subject matter, said method further comprises the step of managing future vaccinations.

In a preferred embodiment, said method further comprises the steps of screening records of a vaccine consumer, and providing notice to a user that a vaccine is appropriate or inappropriate for administration to said vaccine consumer.

In another preferred embodiment, said method further comprises the step of providing a reminder to a user of the need for a periodic vaccination.

In a more preferred embodiment, said periodic vaccination is selected from the group comprising a multiple-injection vaccination course, a seasonal vaccination, a school required vaccination, a work required vaccination, a travel required vaccination, a pediatric vaccination course, a periodic booster vaccination, or combinations thereof.

In a further preferred embodiment, said method further comprises the steps of evaluating an existing, emerging, or forecast pathogenic threat to a vaccine consumer, and providing notice of said threat to a user.

In a preferred embodiment, said threat relates to intended consumer travel.

In another aspect of the inventive subject matter, said method further comprises the step of monitoring a regional vaccination rate and reporting high-risk regions.

In an alternate aspect of the inventive subject matter, said method further comprises the step of securing agreement of a vaccine consumer to limit the liability of a vaccine provider for a vaccine product.

In a further aspect of the inventive subject matter, said method further comprises the step of enabling multi-language operability of said system.

The inventive subject matter additionally relates to a method for substantially guaranteeing an individual vaccine consumer access to at least one dose of vaccine and providing at least one vaccine producer with data for determining seasonal vaccine production quantity using a automated, consumer-driven, vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve more than one dose of vaccine;

accepting or securing financial compensation for said more than one dose of vaccine so reserved; and

enabling said user to donate an unused dose of vaccine so reserved.

Further, the inventive subject matter relates to a method for matching seasonal vaccine supply with seasonal vaccine demand using a consumer-driven reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

accepting or securing financial compensation for said at least one dose of vaccine so reserved; and

providing at least one vaccine producer with access to data for determining seasonal vaccine production quantity.

Additionally, the inventive subject matter further relates to a method for reducing financial risk to vaccine provider using consumer-driven vaccine reservation system, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

securing a guaranty of at least partial payment from said vaccine consumer for said at least one dose of vaccine so reserved; and

securing a commitment from said vaccine consumer for a recurring subscription to multiple vaccines.

Further, the inventive subject matter further relates to a method for reducing a pathogenic infection rate using a consumer-driven vaccine reservation system operable to reserve a dose of vaccine, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

processing a vaccine reservation from a vaccine consumer to reserve at least one dose of vaccine;

securing a guaranty of at least partial payment from said vaccine consumer for said at least one dose of vaccine so reserved; and

securing agreement of a vaccine consumer to limit the liability of a vaccine provider related to a vaccine product.

Further, the inventive subject matter further relates to a method for reducing a pathogenic infection rate using a consumer-driven vaccine reservation system operable to reserve a dose of vaccine, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

providing a substantially automated system for selecting and ordering a dose of vaccine. Said method optionally includes the additional step of providing a reminder to a system user of the need for a periodic vaccination to assist in selecting a vaccine for reservation.

The inventive subject matter also relates to a method for reducing a pathogenic infection rate using a consumer-driven vaccine reservation system operable to reserve a dose of vaccine, comprising the steps of:

providing at least one electronic database having client software configured to receive and store vaccine reservation information;

providing at least one electronic computer system having at least one storage medium configured for hosting said electronic database;

providing at least one human interface for enabling vaccine reservation information to be communicated between said electronic database system and a system user;

providing notice of an existing, emerging, or forecast pathogenic threat to a vaccine consumer to assist in selecting a vaccine for reservation; and

providing a substantially automated system for selecting and ordering a dose of vaccine.

### 1. Primary System and Operational Methods

### FIG. 1 Description and Operation of Vaccine Reservation System:

As depicted in FIG. 1, a generally preferred first embodiment of the vaccine reservation system 10 principally comprises one or more electronic computer databases 12 for receiving, storing, processing (optionally), and/or outputting seasonal vaccine reservations in electronic format, one or more optionally networked electronic computer systems 14, at least one of which has at least one storage medium 17 configured for hosting and optionally operating one or more electronic databases 12 and/or one or more client software interfaces, and one or more typically (but not necessarily) remote, preferably substantially electronically automated, human-interface devices 16 for inputting and/or retrieving vaccine reservation information from the electronic database 12. Such remote human interface devices 16 are generally electronically connected to the computer system 14 and, hence, the database 12 via existing electronic communications infrastructure 18, non-limiting examples of which optionally include the Internet, wired or wireless electronic networks, and/or telephone lines, using one or more typically (but not necessarily) commercially available connection or connection-enabling devices 20 optionally including, as non-limiting examples, routers, servers, modems, and/or the like (not specifically shown).

In greater detail, the electronic database 12 is preferably (but not necessarily) a custom-configured (or client-configured) implementation of a generally commercially available, electronic database software algorithm capable of receiving, storing, processing (optionally), and/or outputting one or more vaccine reservation records, wherein each record comprises one or more data fields related to a particular vaccine reservation for a particular individual or group (such as a family). It is anticipated that the database 12 optionally can also output various results derived from sorting, parsing, summing, and/or otherwise processing the reservation records contained therein for one or more useful purposes as described herein, or as known to the user of the database 12. It is noted that any suitable custom configurable, commercially available, electronic database (e.g., Sybase®, Oracle®, Microsoft® Access, and the like) may be implemented to provide database 12; however, fully customized software algorithms optionally may be utilized to provide all or part of the database system 12. It is further noted that any commercially available and/or custom-authored helper applications and/or sub-applications (e.g., applets, macros, etc.) may be used as part of, or in concert with, the database 12 for processing the data records contained therein, and/or for inputting and/or outputting information from the database 12. The specific apparatus, methods, and/or tools for implementing such a database 12, as well as for manipulating the records contained therein, are well known to those skilled in the art and, thus, do not require further description herein.

The electronic computer system 14 comprises one or more typically (but not necessarily) commercially available, electronic computers 15 (i.e., computing devices) optionally including, as non-limiting examples, a microcomputer, minicomputer, mainframe, workstation, server, portable computer, personal digital assistant (PDA), and/or other electronic computing devices having a means for receiving, storing, processing, and/or outputting information related to one or more vaccine reservations (i.e., capable of hosting all or part of the database 12 and/or capable of manipulating, transacting, communicating, and/or otherwise processing one or more of the data records contained in the database 12 and/or derived from the database 12). In the event that a plurality of electronic computing devices 15 are utilized to provide the electronic computer system 14, one or more of such computing devices 15 are generally (but not necessary) networked as shown in FIG. 1 (as one non-limiting example of connecting the computing devices 15) to form an integrated high-performance system and/or to provide a system having redundant capabilities in the event of failure or other impairment of one or more computing devices 15. It is noted that one or more of the many standard peripheral and/or accessory elements of such computing devices, such as those commonly known to those skilled in the art, are optionally incorporated into the computing system 14 and/or the computing device 15. Non-limiting examples include keyboards, pointing devices, visual display devices, various media reading/writing devices, microphones, sound-emitting devices, and/or the like.

The human-interface device 16 for inputting and/or retrieving vaccine reservation information from the electronic database 12 is preferably (but not necessarily) an internet-connected electronic computing device, optionally similar to one or more of the electronic computing devices 15 used to host database 12 as noted above. More specifically, for inputting a vaccine reservation into the database (i.e., “making a vaccine reservation”) such as by the consumer or a consumer's representative (thereby being a “consumer-driven” system or method), the preferred human-interface device 16 is a consumer-owner, Internet-connected (or otherwise electronically connected) desktop microcomputer, portable computer, PDA, and/or the like. It should be emphasized that by employing such consumer-owned and/or operated computing devices to access the database 12, the capital cost of implementing the present invention on a national or global scale is extremely low.

To facilitate making the reservation, it is anticipated that a suitable graphical user interface (GUI), such as a fill-in type electronic form, is presented (i.e., displayed) to the consumer/user by a human-interface device 16, which typically has at least one visual display device or screen. The methods for presenting and/or collecting information using an interactive graphical user interface are commonly known to those skilled in the art and, thus, need not be further described herein. Nonetheless, it should be noted that a typical electronic form, which may be presented to the user via human interface device 16 to facilitate the reservation of one or more vaccines, would typically (but not necessarily) include one or more labeled fill-in data fields, non-limiting examples of which may include: name, identification number(s), address, phone number, age, gender, preferred vaccine type or types, insurance company data, payment information, and/or the like, plus typically (but not necessarily) one or more process-initiating “radio” buttons (typically on-screen) such as may be used (e.g., electronically activated or “clicked” via pointing device or other human interface device 16) to submit, edit, and/or cancel a reservation, and/or to initiate or terminate one or more other functions related to the present invention.

The invention provides that the vaccine reservation system 10 may incorporate, either alternatively or additionally, one or more alternate devices 16, methods, and/or means for entering one or more vaccine reservations into the database 12 optionally including, as non-limiting examples: (1) a menu-driven telephonic input system, (2) a human-assisted, voice-based telephonic input system (not shown), (3) a voice-based, optionally telephonic, input system which processes reservations by voice-recognition means (not shown), (4) a human-assisted fax-based reservation input form (not shown), (5) a fax-based reservation input form processed by optical character recognition (not shown), (6) an electronic-mail and/or paper-mail input means (not shown) optionally human-assisted and/or assisted by optical character recognition means, (7) a paper-based means employing a human registrar (not shown) who will later enter the reservation into the database 12 via human interface device 16, (8) an optionally network-connected electronic patient care/medical records system (or other personnel records system, such as may be provided by a school, an employer, a government, and/or a military service) optionally capable of automatically selecting and/or reserving one or more vaccines (and/or providing data to computing system 14 to enable system 14 to optionally automatically select and/or reserve one or more vaccines, such as by employing a suitably operable database 12 and/or other software hosted on system 14) for one or more personnel, optionally based on individual personnel data contained in the medical (or other) records system, and/or the like.

Regarding the existing electronic communications infrastructure 18, it is noted that the Internet is the generally preferred means and/or method for interconnecting the computer system 14 hosting the database 12 to the typically (but not necessarily) remote human interface device 16. However, the invention provides that numerous other interconnecting means and/or methods may be employed for this purpose optionally including, as non-limiting examples, one or more standard telephone lines, direct subscriber lines (DSL), satellite links (not shown), other electromagnetic links such as radio frequency (RF) links (e.g., wireless network, “wi-fi”, cellular phone), infrared links, ultrasonic and/or other acoustic links (not shown), and/or the like. It should be noted that such wireless communications technologies (means and/or methods) can greatly facilitate field operations associated with making reservations and/or producing, distributing, and/or administering vaccine.

As noted above, various typically (but not necessarily) commercially available, substantially automated connection devices 20 may be utilized to facilitate or enable the interconnection of the computer system 14, its individual computing elements 15, and/or the various human interface devices 16, wherein connection device 20 may optionally include, as non-limiting examples, one or more routers, servers, modems, and/or the like. However, the invention provides that one or more persons may also be utilized to transfer information related to one or more reservations between the various elements of the system, and/or between the various elements of the system and the primary users of the system (e.g., vaccine consumers). Although not a preferred method of operating the vaccine reservation system 10, the optional addition of human assistants (not shown) to the vaccine reservation system 10 dramatically increases the versatility of the system 10, especially with respect to making reservation for those vaccine consumers (and/or other users of the system including representatives of the consumer, the producers, the shippers, the distributors, the vaccine administrators, and the like) who have either a limited ability or no ability to utilize the various technology-based human interface devices 16.

Additionally, the invention provides that the vaccine reservation system 10 optionally can be operated in (and/or optionally provides a means and/or method for operating in), multiple spoken and/or written languages (e.g., English, Spanish, French, German, Japanese, and/or other languages). Additionally, the invention provides that the vaccine reservation system optionally can directly assist with translating between such different languages (in spoken and/or written form) to facilitate vaccine reservation, production, distribution, and/or administration, the latter of which may be especially useful in highly bilingual or multilingual regions of the world, but also in regions dominated by a single language, where it may be unlikely to find a suitable human interpreter.

FIGS. 2-7 Improved Systems and/or Methods for Producing, Distributing, Administering and/or Evaluating Vaccines:

In addition to the physical elements comprising the consumer-driven vaccine reservation system 10 (including hardware, software, electronic communications infrastructure, and/or other elements), the preferred embodiments of present invention also typically represent and/or comprise one or more improved methods or means for facilitating the efficient production, distribution, administration and/or post-administration evaluation of seasonal vaccine (or other health-critical, long-production-lead-time pharmacological agents). Such improved methods may optionally include, as non-limiting examples: (1) an optional substantially automated method and/or means 30 for substantially guaranteeing access of a particular individual (or group) to one or more health-sustaining and/or life-sustaining doses of vaccine via individual (or group) reservation made generally, but not necessarily, on a pre-production basis using vaccine reservation system 10; (2) an optional substantially automated method and/or means 40 for mitigating the financial risk of vaccine production to the producers of vaccine by providing an optional substantially automated method and/or means for processing compensation to secure from the vaccine consumer (or the consumer's representative) a pre-production payment and/or other financial commitment (such as a refundable monetary deposit which is refundable upon vaccine administration if the vaccine and/or vaccine administration service is subsequently billable to a third party); (2) an optional substantially automated method and/or means 50 for accurately (e.g., precisely) matching seasonal vaccine supply (i.e., production quantities) with seasonal consumer demand by querying the database 12 for the total number and/or type of vaccine reservations, thereby mitigating both health risks due to shortage as well as financial risks due to overproduction; (4) an optional substantially automated method and/or means 60 for facilitating accurate (e.g., precise) regional and/or local distribution of vaccine by querying consumer geographic information optionally contained database 12; (5) an optional substantially automated method and/or means 70 for advising consumers of vaccine availability and/or for reminding consumers of a specific appointment for vaccine administration, optionally via automated generation and/or transmission of appropriate communications to such consumers; and/or (6) an optional substantially automated method and/or means 80 for evaluating the efficacy of, and/or any adverse reaction to, seasonal vaccine by providing various electronic consumer feedback mechanisms optionally including, as a non-limiting example, an interactive, fill-in type, electronic form or survey presented to the consumer via internet-connected computer or any other suitable human interface mechanism 16. In addition, several of the above methods or means can be modified to perform or achieve one or more other useful functions, as will be shown below.

FIG. 2 Description and Operation as a System and/or Method for Substantially Guaranteeing Access to Vaccine:

FIG. 2 depicts an improved method of the present invention in a preferred first embodiment 30 comprising a substantially automated method and/or means for substantially guaranteeing access of a particular individual (or group) to one or more health-sustaining and/or life-sustaining doses of vaccine via individual (or group) reservation made generally, but not necessarily, on a pre-production basis using vaccine reservation system 10.

Briefly, vaccine reservation system 10 and method 30 function in concert to substantially guarantee (baring extreme, unanticipated adverse circumstances) access to vaccine generally by having the consumer of the vaccine (or any authorized individual or organization acting on behalf of the consumer) reserve at least one vaccine in the consumer's name (or by other identifying means) generally, but not necessarily, prior to the commencement of production. The process of reserving a vaccine is generally (but not necessarily) substantially accomplished by the consumer's (or a representative's) use of an electronic human-interface device 16 (such as, for example, a fill-in electronic reservation form presented on an internet-connected computer terminal, a menu-driven telephonic input system, or by other methods noted above) to enter the necessary personal information into database 12 as required to secure one or more vaccine reservations. Confirmation of the vaccine reservation is optionally generally provided to the consumer (or a representative thereof) automatically by the reservation system 10 and/or its operators, typically using one or more of the aforementioned communication processes (e.g., Internet, electronic mail, paper mail, telephone, cellular phone, PDA, facsimile transmission, and the like) and/or devices 16.

In greater detail, as shown in FIG. 2, method 30 for substantially guaranteeing access to vaccine using the consumer-driven vaccine reservation system 10 typically comprises the following steps:
(100) providing a suitable vaccine reservation system 10 enabling direct use by the vaccine consumer (or the consumer's representative) as a means to reserve one or more vaccines (or other pharmacological agents);
(200) having the vaccine consumer (or the consumer's representative) evaluate the need for vaccination and then choose to reserve one or more suitable vaccines to substantially guarantee availability of such vaccines to the consumer;
(300) having the vaccine consumer (or the consumer's representative) electronically access vaccine reservation system 10 typically via optionally remote human-interface device 16 to enter into database 12 the data required to reserve one or more vaccines, typically (but not necessarily) on a pre-production basis;
(400) having one or more producers of vaccine collectively produce vaccine in sufficient quantities to fully meet the needs of all consumers having vaccine reservations;
(500) distributing vaccine to vaccine administration personnel or, optionally, to the consumer (or the consumer's representative) optionally for self-administration if the vaccine is in a suitably safe form (e.g., nasal mist, oral) to permit self-administration; and
(600) administering the health-sustaining and/or life-sustaining vaccine to the vaccine consumer, as substantially guaranteed by using the vaccine reservation system 10.

It should be noted that one or more of the preceding steps of method 30 may contain a plurality of sub-steps; however, the summary of steps presented above, especially when considered in combination with other descriptions and/or depictions of the present invention as disclosed herein, is more than adequate to fully convey to persons skilled in the art the fundamental nature of method 30, as well as how to implement and operate method 30 using the vaccine reservation system 10.

Nonetheless, note that providing a suitable vaccine reservation system per step 100 above generally entails providing a suitable electronic reservation database 12, providing at least one preferably (but not necessarily) internet-connected, electronic computer system 14 having at least one storage medium 17 configured for hosting database 12, and further providing at least one suitable typically (but not necessarily) remote human interface means or device 16 (i.e., an input/output means, such as another internet-connected electronic computer system, a menu-driven telephonic system, an optionally network-connected electronic medical records/patient care system or personnel records system optionally capable of automatically selecting and/or reserving one or more vaccines, and/or the like) for use by the consumer or the consumer's representative when making a reservation. Note that the consumer's “representative” can include, as non-limiting examples, the consumer's guardian, the consumer's health care professional (e.g., doctor, nurse, insurance company), the consumer's employer or school, a benefactor, and/or the like.

Additionally, note that operating the apparatus 10 as provided in step 100 to simply (or only) reserve one or more vaccines using method 30 generally requires only the additional performance of at least steps 200 and 300. Although the performance of only steps 100, 200, and 300 to reserve a vaccine may not fully guarantee ultimate access to vaccine, it may nonetheless provide or establish valuable priority for receiving vaccine in the future. However, steps 400, 500, and/or 600 may optionally be performed to achieve their respective functions and/or benefits, as described herein and/or as shown in FIG. 2, optionally including, but not necessarily limited to, substantially guaranteeing access to one or more vaccines, if all required steps are dutifully performed.

The basic method 30 for guaranteeing access to vaccine by using vaccine reservation system 10 can be altered, modified, and/or supplemented in numerous ways. Briefly, the present invention provides numerous supplemental and/or alternate embodiments optionally including, as non-limiting examples: various supplemental and/or alternate systems and/or methods related to reserving, producing, distributing, administering, and/or evaluating vaccine, whereby such alternate or supplemental systems and/or methods provide significant benefit to one or more consumers of vaccine, and/or to one or more providers of vaccine.

In summary, the present invention provides various primary and/or optional “modules” (i.e., substantially automated systems and/or substantially automated methods) including, as non-limiting examples: one or more modules for:
(1) reserving one or more vaccines, preferably on a pre-production basis (a primary system and/or a primary operational method of the present invention);
(2) educating the consumer about vaccines and/or vaccine administration and, optionally, other related topics;
(3) planning and/or managing personal and/or group vaccinations in the temporal past, present, and/or future;
(4) providing supplemental and/or alternate vaccine reservation functions, such as charitably gifting (i.e., donating) one or more vaccines, and/or registering those in need of a charitably gifted or donated vaccine;
(5) processing compensation for one or more vaccines and/or for one or more vaccine-related items and/or services,
(6) efficiently producing vaccine; and/or optionally managing vaccine production facilities and/or personnel;
(7) efficiently distributing vaccine, and/or optionally managing vaccine distribution facilities and/or personnel;
(8) efficiently administering vaccine; and/or optionally managing vaccine administration facilities and/or personnel;
(9) reporting and/or evaluating the efficacy of vaccine and/or the quality of vaccine-related items and/or services;
(10) verifying compliance with one or more vaccine protocols and/or requirements;
(11) providing information security and/or financial security to one or more vaccine consumers and/or related entities;
(12) limiting the legal and/or financial liability of one or more producers and/or other providers of vaccine; and/or
(13) providing multi-language operation and/or language translation within the basic vaccine reservation system and/or alternate embodiments thereof.

Note that each of the alternate and/or supplemental (i.e., non-primary) embodiments listed above (e.g., items 2-13) may be described as an optional accessory “module” comprising one or more systems and/or methods. However, it is emphasized that certain modules may not be “optional” when performing one or more specific functions. Each of these alternate and/or supplemental embodiments will be discussed in greater detail herein below.

It is further emphasized that the present invention anticipates that such optional modules (i.e., optional systems and/or optional methods) may be incorporated into the basic method 30 and/or system 10 in any useful combination for one or more purposes described herein and/or as known to the user of the present invention. Further, the invention provides that one or more of the optional systems and/or optional methods (i.e., optional modules) may be implemented and/or operated independently of method 30 and/or system 10. Further, the invention anticipates that method 30 and/or system 10 may be used for other useful purposes (and/or to achieve other useful results) without departing from the nature of the invention.

2. Supplemental Systems and/or Methods for Educating Vaccine Consumers

To enhance the vaccine consumer's general understanding of pathogenic threats, available vaccines, typical vaccination procedures, and/or specific requirements for vaccination (but also to improve the vaccine consumer's ability to use the subject vaccine reservation system), the present invention further provides optionally providing one or more substantially automated systems and/or methods operable to educate the vaccine consumer and/or the vaccine consumer's representative, as well as any other user of the system.

In particular, the invention provides providing one or more optional substantially automated educational modules addressing topics including, as non-limiting examples: (1) the general health risks infectious pathogens pose to potential vaccine consumers; (2) the typical vaccines which may be employed to mitigate such pathogenic threats or risks; (3) typical vaccination schedules indicating required and/or recommended vaccinations, e.g., a pediatric or “childhood” series of vaccinations (i.e., pediatric vaccination course); (4) specific, optionally real-time, current and/or forecast pathogenic threats for a particular geographic region; and/or (5) specific vaccines which may be either appropriate or inappropriate for a particular consumer, typically based upon personal data (e.g., age, gender, existing medical conditions, medications taken by the consumer, and/or other personal attributes).

Additionally, the invention provides optionally providing one or more optional substantially automated educational modules (systems and/or methods) addressing one or more complementary non-vaccine-related techniques for mitigating the risks posed by pathogenic threats, non-limiting examples of which optionally include: (1) maintaining a healthy immune system via proper diet, dietary supplements, physical exercise, and/or rest, (2) maintaining proper personal hygiene and/or environmental cleanliness, (3) maintaining reduced physical and/or psychological levels of stress, and/or (4) avoiding or minimizing close contact with known carriers and/or possible carriers of infections pathogens.

Further, the invention provides optionally providing one or more substantially automated educational modules describing proper use of the basic vaccine reservation system of the present invention (e.g., describing one or more of its systems, elements, methods, operating procedures, preferred practices, and/or the like). Additional and/or expanded educational modules optionally may be provided to further describe proper use of one or more of the supplemental and/or alternate aspects of the present invention.

Note that such educational modules optionally can be incorporated into the vaccine reservation system as a separate module that is preferably (but not necessarily) used prior to operating the other modules (i.e., systems and/or methods) of the present invention. However, such educational modules alternatively and/or supplementally may be incorporated into one or more of the other primary, supplemental, and/or alternate modules (i.e., systems and/or methods) of the present invention, such as the aforementioned optional vaccine planning and management system, which will be described in greater detail below. Note that by either incorporating or electronically linking one or more educational modules into one or more other modules (i.e., systems and/or methods) of the invention, the user of a particular system will be able to readily access information related to the particular system or function (or access other user-selectable information) while working within that particular system or module.

Nonetheless, one or more educational modules may be incorporated into the system 10 and/or method 30 such as by modifying step 200 to optionally include one or more sub-steps (not shown) including, as non-limiting examples: a step for providing and retrievably storing predetermined educational information in storage medium 17; a step for providing an information retrieval system (preferably, but not necessarily, a commercially available Internet “web browser” or the like) operable to retrieve and present the stored educational information to a user or operator via human interface 16; and optionally operating the retrieval system to access the stored educational information by operably selecting (such as by using a pointing device or other human interface device 16) one or more items of educational information to be accessed. It is anticipated that such educational information will typically, but not necessarily, be presented to the user in the form of short articles, graphical depictions, and/or digital video and/or audio files; however, to promote structured learning, note that the stored educational information can optionally be presented to the user in the form of one or more dynamic, optionally interactive, educational tutorials.

To extend the range of information available to the operator of system 10 (if using an appropriate human interface device 16), the present invention further provides providing one or more optional dynamic electronic links (e.g., hyperlinks) to access vaccine-related information (or other information) provided and stored by one or more external entities (e.g., information such as may be provided on the “web site” of the Center for Disease Control, or CDC, based in the United States).

Similarly, the present invention also provides optionally providing dynamic electronic links to vaccine-related commercial and/or non-commercial entities, and further provides providing optional commercial advertising space on a visual display or other type of human interface 16 (such as by incorporating the advertising space into a predetermined region of a graphical user interface, electronic form, Internet web page, and/or the like). Note that such advertising space may provide a source of advertising revenue, which may be used to maintain or improve an implemented vaccine reservation system. Considering the highly critical functions and the specialized market sector addressed by of the present invention (i.e., vaccines and/or vaccine-related services), an excellent opportunity exists for highly-targeted advertising within the broader vaccine-related economic community. To exploit this economic opportunity, the present invention further provides optionally providing one or more substantially automated compensation processing systems and/or methods operable to collect advertising revenue and/or referral revenue, such as one or more of the many systems and/or methods known to those skilled in the art.

3. Supplemental Systems and/or Methods for Planning and Managing Consumer Vaccinations

To facilitate proper selection, efficient scheduling, and/or thorough documenting of one or more vaccines, the present invention further provides optionally providing one or more substantially automated systems and/or methods for planning and/or managing personal vaccinations, optionally including temporally past, present, and/or future vaccinations.

Briefly, a “Vaccination Planning and Management System” can be configured to serve as a highly effective tool operable to perform one or more functions including, as non-limiting examples: (1) assisting the user of the system to quickly and accurately select one or more vaccines that are medically and, optionally, economically appropriate for the intended vaccine consumer; (2) assist the user in temporally and/or spatially (i.e., location) scheduling one or more vaccinations for the intended consumer, such as scheduling a pediatric series of vaccinations (i.e., a pediatric vaccination course), which typically comprises numerous vaccinations administered over a fairly rigorous multi-year schedule; and/or (3) documenting the various vaccinations-administered to a consumer to create an optionally permanent, optionally portable, optionally electronic and/or optionally electronically readable vaccination record, which may optionally include one or more other items of pertinent data, non-limiting examples of which may include: name and/or other unique identifier(s); name of guardian, if applicable; contact information, such as postal mailing address, electronic mail address, and telephone number(s); vaccine producer; vaccine serial number and/or manufacturing batch identifier; vaccine administration date, administration personnel, and/or administration facility; any observed adverse reactions to and/or adverse effects of vaccine; known allergies; concurrent medications and/or vaccines; the consumer's primary care physician or other physician; contact information for one or more physicians; and/or the like.

Regarding general configuration and operation, first note that the substantially automated Vaccine Planning and Management System (or module) typically operates by (1) collecting and/or accessing data pertinent to the current life status of a prospective vaccine consumer including specific personal and/or medical data; (2) collecting and/or accessing data regarding vaccination requirements and/or recommendations; (3) collecting and/or accessing data regarding specific vaccines, preferably including specific limitations and/or prohibitions on use; (4) logically comparing the aforementioned collected and/or accessed data to determine which vaccine or vaccines are appropriate, inappropriate, and/or prohibited for use by the prospective vaccine consumer based on the consumer's current life status; (5) reporting the results to the user or operator for review, modification, and/or acceptance; and (6) optionally documenting one or more acceptable vaccinations, preferably by optionally electronically storing the user-accepted vaccinations in suitable format to provide an optionally portable electronic “Personal Vaccination Plan” (or equivalent) for subsequent use, whereby a highly rigorous and comprehensive analysis optionally can be performed to determine one or more vaccinations appropriate for the prospective vaccine consumer, yet require minimal effort by the user of the Vaccine Planning and Management System. In addition to the general processes described above, note that the Vaccine Planning and Management System optionally can be configured to further act upon the “Personal Vaccination Plan” and/or one or more of the prospective vaccinations contained therein, examples of which will described herein below.

Regarding implementation, note that a relatively simple embodiment of a Vaccine Planning and Management System or module (comprising one or more systems and/or methods) can be readily implemented such as by modifying vaccine reservation system 10 and method 30. In particular, implementation typically requires augmenting step 200 of method 30 to provide via sub-step 210 (not shown) one or more suitably configured information collecting and/or information accessing devices operable to electronically solicit and collect (and/or operable to access stored data to collect) one or more items of data from one or more sources of data; collect and/or access relevant information or data via sub-step 220 (not shown), typically, but not necessarily, including (a) personal data and/or medical data of the prospective vaccine consumer, (b) vaccination requirements data (e.g. the pediatric medical requirement for submitting to a pediatric series, a travel requirement to be vaccinated against Yellow Fever or other pathogenic threat, a school requirement that a student be vaccinated against polio or other diseases, and the like), and (c) vaccine data including appropriate, inappropriate, and/or prohibited uses of the vaccine; logically comparing via sub-step 230 (not shown) the collected and/or accessed data using an appropriate provided operable logical computer algorithm (not shown) to determine one or more vaccinations that are appropriate and/or inappropriate (e.g., potentially not safe) for the prospective vaccine consumer; and reporting to a user of the system via sub-step 240 (not shown) information regarding one or more appropriate and/or inappropriate vaccinations for the prospective vaccine consumer.

In greater detail, note that various optional systems and/or processes may be provided to collect or access the information required to select one or more vaccines appropriate for a prospective vaccine consumer (and/or to collect or access data for other purposes described herein). As one non-limiting example, data may be collected via human interface device 16 using one or more fill-in type electronic forms such as those previously described, optionally including one or more electronic menu selections to facilitate entering different types of data and/or to select between various presented menu options. As a second non-limiting example, the data may be collected by electronically linking to one or more sources of retrievable data, such one or more electronic databases 12 and/or one or more other electronic files containing the required information.

In particular, note that personal or life status data related to the prospective vaccine consumer can be solicited and collected directly from the consumer or other user of system 10 and/or method 30, such as by using one or more fill-in electronic forms, and/or alternatively collected by electronically linking to one or more electronic medical records systems and/or other electronic personal (or personnel) records systems containing appropriate information about the prospective vaccine consumer.

Similarly, data related to vaccination requirements can be collected and/or accessed by similar systems, processes, and/or methods. However, for purposes of accuracy and efficiency, the preferred method for collecting vaccination requirements data is by electronically linking to one or more electronic sources of such data, preferably provided (and regularly updated) by the entity having responsibility for establishing and/or enforcing such vaccination requirements. As a non-limiting example, it is anticipated that vaccination requirements for enrolling a child in a particular school can be obtained by electronically linking to electronic data prepared, hosted, and/or provided by the particular school authorities and/or the local public health agency.

Further, data regarding one or more vaccines, including appropriate, inappropriate, and/or prohibited uses of such vaccines, may also be collected and/or accessed by similar systems, processes, and/or methods. Once again, for purposes of accuracy and efficiency, the preferred method for collecting such vaccine data is by electronically linking to one or more electronic sources of such data, preferably provided by (and regularly updated by) the entity or entities having responsibility for developing, regulating, and/or administering vaccine. As a non-limiting example, the invention anticipates providing access to such vaccine data by electronically linking to electronic data prepared, hosted, and/or provided by one or more agencies, such as the Center for Disease Control (CDC).

It is anticipated that information regarding the consumer, vaccination requirements, and/or vaccines optionally can be provided on, and subsequently retrieved or collected from, one or more electronically readable storage media, such as a compact disk (CD) and/or the like; however, the reader is cautioned that the information contained therein may be subject to rapid obsolescence.

As noted above, the present invention further provides optionally providing a substantially automated system and/or method for screening prospective vaccine consumers for possible adverse reactions to vaccine. As further noted above, such a “Screening System” is also useful for aiding the process of selecting the most appropriate vaccines for a prospective vaccine consumer, typically based on the current life status of the prospective vaccine consumer, vaccination requirements, and specific vaccine information. Now in greater detail, significant amounts of data typically need to be acquired and logically compared to properly screen the prospective vaccine consumer. In particular, the typically (but not necessarily) large amount of personal data to be collected from the prospective consumer may include, as non-limiting examples: age, gender, general health status, specific existing medical conditions, current medications, known allergies, previous vaccinations, and/or other relevant data. Similarly, proper screening requires a significant amount of data for each prospective vaccine, non-limiting examples of which typically include: tendency to induce allergic response; age or ages not appropriate for vaccination; other medication conditions for which the vaccine is not appropriate; possible and/or known adverse interactions with other vaccines, medications, and/or other pharmacological agents; an the like. Considering the health-critical nature of properly screening consumers for potential adverse interactions with vaccine, the value of such a substantially automated system that is operable to collect and logically compare the vast amounts of relevant data, typically with relatively little or no human assistance, should not be underestimated. Accordingly, the invention anticipates that the Screening System may be used valuably as a substantially independent system, which can be readily configured by simply modifying system 10 and method 30 to incorporate only the necessary elements and functions, each of which has been defined above, as required to perform the screening function.

In addition to the processes described above, the Vaccine Planning and Management System can be configured to further act upon the “Personal Vaccination Plan” (or an equivalent electronic file) and/or one or more of the prospective vaccinations contained therein. As one non-limiting example, note that the electronically stored Personal Vaccination Plan (or information on one or more prospective vaccinations) optionally can be automatically electronically forwarded (using system 10 via any practical electronic communications method, such as those described herein or as known to one skilled in the art) to the intended vaccine consumer's physician and/or other competent person, whereby the physician and/or other competent person can review, modify, reject, and/or accept the Personal Vaccination Plan, or portions thereof, and optionally certify his or her review and/or approval (or authorization) of the Plan, such as by providing a digital signature using an optionally provided digital signature recording device, which is another example of a human interface device 16. Note that this physician review process provides an effective method for further ensuring the integrity and safety of a particular Personal Vaccination Plan.

As a second non-limiting example, the electronically stored Personal Vaccination Plan (or an equivalent electronic file) optionally can be used as the data source for one or more vaccines that need to be temporally and/or spatially (e.g., geographically) scheduled, and/or reserved. In particular, by optionally further providing and using a substantially automated “Vaccination Scheduling System”, spatial-temporal appointments for one or more future vaccinations can be quickly and easily scheduled, such as by additionally (1) collecting (and/or accessing) the personal schedule of one or more prospective vaccine consumers, one or more schedules regarding vaccine availability, and one or more schedules for vaccine administration personnel and/or a vaccine administration facility, and (2) logically comparing these schedules to determine one or more mutually acceptable spatial-temporal appointments for administering vaccine to one or more perspective vaccine consumers, whereby a potentially complicated scheduling process can be completed by the user of system 10 and method 30 (as augmented hereinabove) with relatively little effort.

Additionally, the vaccination data contained within the electronic Personal Vaccination Plan (or an equivalent electronic file) can be accessed by (or transmitted to) the vaccine reservation module (generally, system 10 operating in conjunction with step 300 of method 30) to substantially automatically reserve one or more (or all) of the identified vaccinations in a single reservation transaction or, optionally, multiple transactions. Accordingly, by optionally operating the noted reservation module in conjunction with other optional modules of the present invention (in particular, the planning and management module), system 10 is, thus, operable to almost instantaneously plan, schedule, and/or reserve one more vaccinations and/or one or more complex series of vaccinations, such as the aforementioned pediatric series, while requiring only a few simple instructions by the user of the vaccine reservation system 10.

The present invention further provides optionally providing a substantially automated system and/or method for reminding prospective vaccine consumers of the need for regular vaccinations, such as a seasonal influenza vaccine, or perhaps a tetanus booster vaccination, which is given so infrequently (typically every tenth year) that even the most diligent vaccine consumer tends to forget when he or she is due for the next tetanus booster. Such reminders can be readily generated by system 10 simply by periodically communicating to the vaccine consumer (or representative of the consumer) the general need for one or more unplanned vaccinations or, alternatively, one or more previously planned or scheduled vaccinations, such as might typically be stored in a Personal Vaccination Plan as described above (or in an equivalent electronic file), typically using one or more of the many communications methods described herein. It should be noted that such reminders tend to significantly enhance the probability that a prospective vaccine consumer will remember to plan, schedule, reserve, and/or present himself or herself for one or more vaccinations.

The present invention further provides optionally providing a substantially automated system and/or method for collecting, evaluating and/or reporting general pathogenic threats to the vaccine consumer, optionally including historical threats, current threats, and/or forecast threats, the results which may be used either for general information, or as an optional data source (such as for step 220) to be evaluated (such as by step 230) when planning vaccinations that may be required and/or recommended. Note that threat data can be collected by various methods, such as by simply electronically linking system 10 to an external source of threat information, such as the Center for Disease Control or similar organizations, which periodically compile and make available such threat data. Alternatively, system 10 optionally can be employed to solicit wellness data directly from the users of system 10, whereby reports of illness by the users can be analyzed and compiled by system 10, and/or directly reported to the users of the system and/or to one or more external organizations such as the CDC. Additionally, system 10 optionally can be instructed to alert one or more users of the system upon the condition that a pathogenic threat rises above a predetermined level, wherein the pathogenic threat may be determined via electronic link to an external source of threat data such as the CDC and/or determined by evaluating the user-provided illness data.

The present invention further provides optionally providing a substantially automated system and/or method for identifying vaccinations that are either required or recommended for persons traveling or planning to travel to particular regions of the world. System 10 can be readily employed to determine any required and/or recommended vaccinations appropriate for a particular travel itinerary, simply by having the user additionally input the itinerary of the traveler into the system for subsequent use by the previously described Vaccination Planning and Management System, which can then automatically access the vaccination requirements for the intended travel destinations to determine required vaccinations, optionally screen the consumer in relation to any required or recommended vaccinations for medical appropriateness (using the previously mentioned screening system), and report the required and/or recommend vaccinations that are optionally medically appropriate, if any, to the user.

The present invention further provides optionally providing a substantially automated system and/or method for tracking and/or evaluating travel by a prospective vaccine consumer to determine any possible needs for vaccination and/or other precautionary medical treatment, based upon the spatial (e.g., geographic) locations to which the consumer has traveled, the temporal dates during which the consumer was present in the particular locations (i.e., the travel itinerary), and the pathogenic threats known or believed to exist at such times and at such locations, if any. System 10 can be readily employed to determine any significant risk of pathogenic exposure by inputting the completed travel itinerary into system 10, collecting pathogenic threat data for each location and time provided in the travel itinerary, and subsequently evaluating and reporting the possibility and/or probability of exposure to one or more pathogenic threats. To further automate this function, a location monitoring device, such as a Global Positioning System (or GPS) device can optionally be provided to the traveler to automatically record and/or optionally automatically input the itinerary into the system, thereby optionally enabling substantially real-time evaluation of exposure to pathogenic threats.

The present invention further provides optionally providing a substantially automated system and/or method for monitoring and reporting vaccination rates (e.g., the number and/or fraction of the population which have been vaccinated), such as in various regions of the world, nation, and/or a local community. Note that vaccination rate data can be collected by various methods, such as by simply electronically linking system 10 to an external source of vaccination rate data, such as the Center for Disease Control or similar organizations, which periodically compile and make available such vaccination rate data. Alternatively, system 10 optionally can be employed to solicit vaccination data directly from the users of system 10, whereby reports of vaccination by the users can be analyzed and compiled by system 10 to generally determine vaccination rates. The vaccination rate data can then be communicated to the users of the system (or other parties) for such purposes as evaluating whether or not to travel to an area with low vaccinations rates, which frequently experience higher infection rates. Note that this function may be of particular importance to a prospective traveler who is unable to be vaccinated for medical or other reasons.

4. Alternate Systems and/or Methods for Reserving Vaccines

a. Supplemental Reservation Functions

In addition to the basic reservation systems and methods described hereinabove, the present invention further provides optionally incorporating one or more alternate and/or supplemental reservation functions.

As one non-limiting example, the present invention provides optionally further including a substantially automated system and/or method for permitting the consumer to select and reserve a particular type of vaccine including, for example, (1) the method of vaccine administration (i.e., hypodermic injection, nasal mist, oral, and the like), (2) the particular strain (or strains) of pathogen (or pathogens) that the consumer wishes to be protected against via one or more vaccines (optionally including the ability to specify a custom-produced vaccine for a particular individual or group), and/or (3) the method of vaccine production (e.g., pathogen incubation within the egg of a chicken or, alternatively, some non-allergenic method of vaccine production). As a non-limiting example, system 10 and method 30 can be modified to perform this function simply by further providing (1) one or more electronic menus (or other human interface) operable to present various types of vaccine to allow selection by the user, and (2) one or more corresponding additional data fields within each electronic reservation data record operable to receive and store such vaccine type information. Note that the modifications to method 30 would typically entail modifying step 300 to incorporate the noted additional aspects. In addition to manually selecting one or more types of vaccine from an electronic menu, note that the aforementioned Personal Vaccination Plan can be accessed to alternatively enable automatic reservation of one or more types of vaccines, such as those listed in a particular Personal Vaccination Plan.

As second non-limiting example, the present invention provides optionally further including a substantially automated system and/or method for reserving or “subscribing” to a plurality of vaccines over a finite or, optionally, an indefinite period of time, wherein the burden upon the consumer associated with reserving (or otherwise procuring) multiple vaccines is significantly reduced. Once again, as a non-limiting example, system 10 and method 30 can be modified to perform this function simply by further providing (1) one or more electronic menus (or other human interface) operable to present vaccine subscription options selectable by the user, and (2) one or more additional data fields within each electronic reservation data record operable to receive and store such subscription information. Note that the modifications to method 30 would, once again, typically entail modifying step 300 to incorporate the noted additional aspects. The invention anticipates that various types of subscriptions can be established, optionally including as non-limiting examples: fixed-term seasonal vaccine subscriptions of varying duration (e.g., three-year, five-year, etc.); indefinite-term seasonal vaccine subscriptions (e.g., subscription which will continue in perpetuity unless cancelled); and/or subscriptions to a specific course of vaccinations, such as a pediatric vaccination course (or series). As an alternative to manually selecting one or more vaccine subscriptions from an electronic menu, note that the aforementioned Personal Vaccination Plan can be accessed to alternatively enable automatic reservation of one or more vaccine subscriptions, such as may be listed in a particular Personal Vaccination Plan.

Note that compensation (which will be discussed in greater detail hereinbelow) for a vaccine subscription optionally can be processed, as non-limiting examples: as a single transaction (e.g., one-time payment), or as a series of transactions (e.g., periodic payments) typically, but not necessarily, corresponding to the production, distribution and/or administration schedule for the doses of vaccine comprising the subject vaccine subscription. Further, it is anticipated that recurring electronic payments for a vaccine subscription optionally can be automatically periodically processed such that the vaccine subscriber (or the subscriber's representative) need only authorize the series of payments one time, instead of having to authorize each periodic payment individually, thus greatly facilitating compensation processing for vaccine subscriptions.

As another example, to guard against possible unexpected disruptions in the production (and/or distribution and/or administration) of vaccine, the present invention provides optionally providing a substantially automated system and/or method for reserving a plurality of doses of vaccine for an individual vaccine consumer (typically including at least one primary dose of vaccine and at least one redundant or spare dose of vaccine for use in the event of loss of the primary dose), wherein the plurality of doses of vaccine are optionally produced, as non-limiting examples: (1) by the same producer, optionally at the same plant site, and optionally in the same production batch; (2) by the same producer, but optionally in distinctly different production batches; (2) by the same producer, but optionally at distinctly different plant sites; (3) by different producers; (4) by producers at different geographic locations and/or plant sites; (5) by producers within different political and/or other authoritative boundaries; and/or by some other practicable production arrangement. Again, as a non-limiting example, system 10 and method 30 can be modified to perform this function simply by further providing one or more electronic menus (or other human interface) operable to present various production options selectable by the user. Note that the modifications to method 30 would, once again, typically entail modifying step 300 to incorporate the noted additional aspects.

Similarly, to guard against possible unexpected disruptions in the distribution and/or administration of vaccine, the present invention further provides optionally providing a substantially automated system and/or method for separately distributing and/or administering the plurality of vaccines to the consumer. Again, as a non-limiting example, system 10 and method 30 can be modified to perform this function simply by further providing one or more electronic menus (or other human interface) operable to present various distribution and/or administration options selectable by the user. Note that the modifications to method 30 would, once again, typically entail modifying step 300 to incorporate the noted additional aspects.

As another example of a modified or alternate configuration of the invention, the invention further provides optionally providing a substantially automated system and/or method for pre-authorizing (and for optionally pre-paying) the possible future production of one or more vaccines (which optionally are substantially undetermined at the time of pre-authorization by the prospective vaccine consumer), such as would be appropriate for a currently unknown, unexpected, and/or possibly emerging pathogenic threat (e.g., a highly virulent strain of avian influenza virus that might mutate to become highly infectious and lethal to humans, a biological warfare agent, etc.), whereby the production of one or more such pre-authorized vaccines can commence as soon as practicable once the pathogenic threat is identified, thereby rendering the vaccine available to the consumer as soon as practicable. Again, as a non-limiting example, system 10 and method 30 can be modified to perform this function simply by further providing one or more electronic menus (or other human interface) operable to present one or more pre-authorization options selectable by the user, and by optionally collecting and evaluating pathogenic threat information (such as by means described herein above) that can be used to determine if a threat has exceed some predetermined level, which, if exceeded, would trigger the start of production of the pre-authorized vaccine. Note that the modifications to method 30 would typically entail modifying step 300 and, optionally, step 200 (optionally including one or more sub-steps thereof) to incorporate the noted additional aspects.

As another example of a modified or alternate configuration of the invention, the invention further provides providing a system and/or method for reserving and storing, optionally at a predetermined location (optionally user-specified), one or more existing and/or future-produced vaccines for the exclusive future use of the particular consumer. Such a system and/or method is particularly useful for guaranteeing access to little-used agents, such as anti-biological warfare agents, which are generally not available in sufficient quantities (globally, nationally, and/or locally) for all persons in the unlikely event of a crisis. Further, such systems and/or methods are useful for ensuring that currently available vaccine will be available at some future date when it is more medically appropriate for the consumer to receive the vaccine. For example, a pregnant mother may wish to reserve a flu vaccine for future administration, when it is less likely to interfere with her pregnancy. Again, as a non-limiting example, system 10 and method 30 can be modified to perform this function simply by further providing one or more physical storage facilities operable to store one or more vaccines, preferably located or “pre-positioned” in close proximity to the vaccine consumer to enable rapid access to such vaccine by the vaccine consumer in a time of need. Note that the modifications to method 30 would, once again, typically entail modifying step 300 to incorporate the noted additional aspects.

As another example of a modified or alternate configuration of the invention, the invention further provides optionally providing a substantially automated system and/or method for acquiring authorization from a parent or legal guardian of one or more dependent persons (e.g., a school age child, a disabled adult, or a dependent elderly person), such as to authorize administration of one or more vaccines to the dependent person. Note that system 10 can perform this function by employing substantially the same means and methods employed for conducting a physician's review of a personal vaccination plan, as previously described hereinabove.

As another example of a modified or alternate configuration of the invention, the invention further provides optionally providing a substantially automated system and/or method for aggregating a plurality of individual consumers (or other users) and/or small groups of consumers into one or more larger groups of consumers to optionally (1) facilitate or enable access to vaccine and/or vaccination service, and/or (2) reduce the cost of vaccine and/or vaccination service, typically as a result of the superior bargaining power of the larger group within a free-market economy. Once again, as a non-limiting example, system 10 and method 30 can be modified to optionally perform this function simply by further providing (1) one or more electronic forms (or other human interface) operable to provide information to system 10 that the user is amenable to being aggregated with other users to form a larger group of users for one or more purposes as noted above and/or other purposes, and (2) processing the user information regarding aggregation to establish one or more aggregated groups of users. Note that the modifications to method 30 would, once again, typically entail modifying step 300 to incorporate the noted additional aspects.

As another example of a modified or alternate configuration of the invention, the invention further provides optionally providing a substantially automated system and/or method for randomizing the order in which the names of a plurality of consumer-selectable optional providers of vaccine are presented (such as within a list of providers presented via visual display device or other human interface), to the consumer for selection by the consumer, whereby the providers have substantially equal or “fair” opportunity to be presented to the consumer in a preferred position within a list of the providers, such as the top or beginning of the list or providers. Once again, as a non-limiting example, system 10 and method 30 can be modified to optionally perform this function simply by further providing one or more electronic forms having an electronic menu (or other human interface) operable to provide a randomized list of providers to a user for selection by the user, wherein a further provided randomizing software algorithm is operated to randomize the provided list of providers. Note that the modifications to method 30 would, once again, typically entail modifying step 300 to incorporate the noted additional aspects.

b. Systems and/or Methods for Gifting Vaccines

As still another example of a modified configuration, the present invention further provides optionally providing a substantially automated system and/or method for allowing individuals or other benefactors (or donors), to charitably gift (or donate) one or more vaccines to persons in need of vaccine (or donees), but who are of limited financial means. To facilitate such charitable gifting of vaccines (or other medical services), the invention also provides optionally providing a substantially automated system and/or method for registering individuals in need of, and optionally authorized to receive via evaluation by system 10 or by some authorizing agency (e.g., a social welfare office and the like), one or more vaccines via charitable gift. In addition, the invention provides that such charitable gifts can be made directly to a particular needy individual or group, or to some unspecified individual or group, and that the donated vaccine may optionally be vaccine which is reserved and purchased specifically as a charitable gift, or vaccine which represents a vaccine consumer's “spare” or “redundant” dose of vaccine in the event that the spare dose of vaccine is not needed by the individual.

Once again, as a non-limiting example, system 10 and method 30 can be modified to optionally perform this function simply by further providing (1) one or more electronic forms (or other human interface) operable by a user to provide information to system 10 regarding a specific donee (e.g., the individual person or organization receiving the donated vaccine) Note that the modifications to method 30 would, once again, typically entail modifying step 300 to incorporate the noted additional aspects. Note that similar methods and/or means optionally can be used to register a prospective donee, or several prospective donees, in need of a donated dose of vaccine.

As still another example of a modified configuration, the present invention further provides optionally providing a substantially automated system and/or method for allowing the vaccine consumer (or consumer representative) to designate one or more beneficiaries to receive the proceeds or profits (or partial proceeds or profits) from the consumer's one or more vaccines (or other medical services). Further, to facilitate such designation of such profits or proceeds to one or more suitable beneficiaries, the invention also provides optionally providing a substantially automated system and/or method for registering suitable beneficiaries (e.g., a charitable non-governmental organization, an educational institution, a medical research institution, and the like). Note that the systems and/or methods required to implement these functions are substantially identical to the system and/or methods required to implement the functions related to charitable gifting of vaccines as described in the two preceding paragraphs.

It should be noted that such opportunities for charitable gifting also provide an excellent financial incentive to the donor to donate vaccine, other medical services, and/or the proceeds or profits from such vaccines and/or services, as a result of the potential tax-deductible status of such charitable donations or contributions within various taxing-levying governmental jurisdictions. To facilitate reporting such potentially tax-deductible charitable contributions (for such purposes as preparing tax-related information for taxing-levying governmental jurisdictions), the present invention further provides optionally providing a substantially automated system and/or operational method for reporting or communicating such charitable contributions to the benefactor and/or some other entity optionally specified by the benefactor including, as non-limiting examples, the benefactors accountant, tax-levying jurisdiction, and the like. It is anticipated that such information can be communicated by one or more of the many communications methods described herein.

In addition to the tax-related financial incentives offered to the consumer for such charitable contributions, it should also be noted that the present invention further provides providing other systems and/or methods for providing financial incentives related to vaccination, several non-limiting examples of which include providing monetary discounts for (1) reserving a plurality of vaccines for a group (e.g., a family, school, employer, aggregated group of unrelated individuals, and the like) typically via single reservation transaction, (2) fully or partially paying for one or more reserved vaccines prior to the commencement of production (i.e., “pre-paying”), and/or (3) electing to subscribe to a plurality or periodic (e.g., yearly, seasonal, etc.) vaccinations for the number of years (by using a suitable system and/or method optionally incorporated into reservation system 10. Note that these modifications to method 30 would typically entail modifying step 300 to incorporate the noted additional aspects.

It is emphasized that method 30 for reserving one or more doses of vaccine is generally the most critically important aspect of the present invention from a humanitarian perspective, especially considering that reliable (e.g., substantially guaranteed) access to vaccine is necessary for saving the lives of thousands of persons annually, and preserving the general health of millions more. However, method 30 is also of great economic value being that its reservation processing function optionally may be combined with a financial compensation processing function, wherein the combination of these functions is operable to significantly reduce financial risk to the providers of vaccine (e.g., the producers, distributors, administrators, and/or transaction agents), as will be shown below. Further, the data contained within database 12 (as a result or implementing method 30, steps 100-300) also has significant economic value in that such data can be readily utilized to more accurately balance seasonal vaccine supply and demand, thereby again significantly reducing financial risks associated with vaccine production, distribution, and/or administration, and for other purposes, as will be further shown herein below.

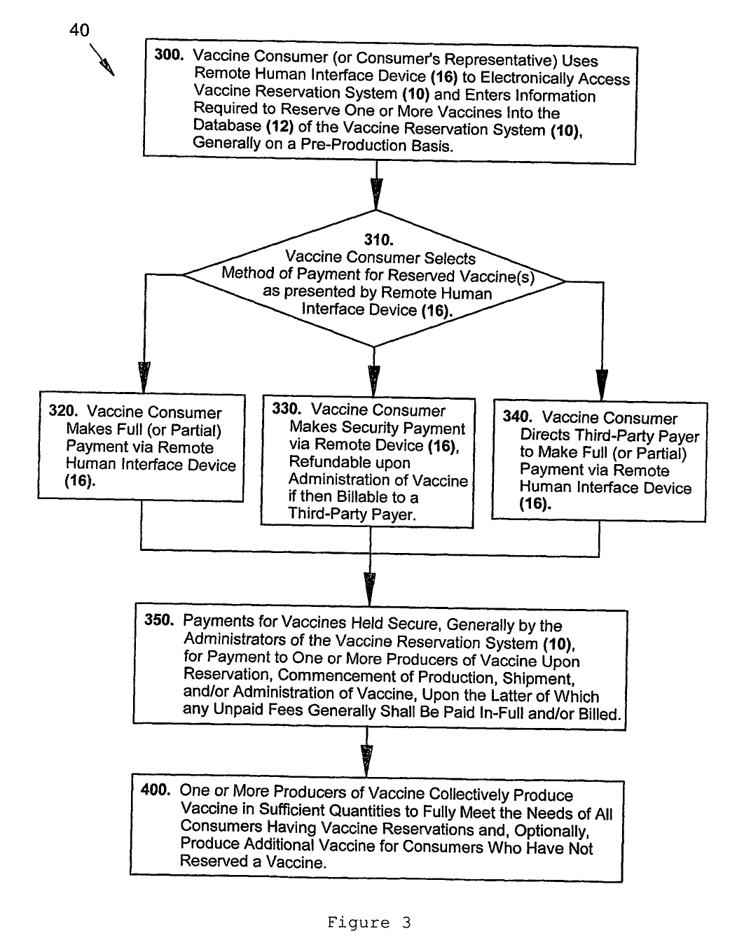

5. Systems and/or Methods for Processing Compensation
FIG. 3 Description and Operation as a System and/or Method for Processing Compensation to Mitigate Financial Risk:

FIG. 3 depicts an alternate embodiment 40 of the present invention comprising an optional substantially automated system and/or method 40 for processing compensation for such non-limiting purposes as mitigating or reducing the financial risk of vaccine production to the producers of vaccine and/or other financially interested parties. Note that such financially interested parties may optionally include, as non-limiting examples: one or more vaccine producers, distributors, administrators and/or transaction agents, a governmental health agency having responsibility for underwriting or securing the producer's investment, and/or a non-governmental (perhaps charitable) organization heavily involved in global vaccination efforts.

Briefly, method 40 generally comprises providing an optional system and/or method operable for securing from the vaccine consumer and/or other entity (e.g., the consumer's representative, benefactor, and/or third-party payer) a pre-production payment or compensation (e.g., monetary compensation, an in-kind donation, and/or volunteer service) and/or other financial commitment (such as a refundable performance-inducing monetary deposit, which is refundable to the consumer, the consumer's representative, and/or a benefactor upon or after vaccine administration, if the administered vaccine is subsequently billable to a third party payer). It is noted that method 40 is generally a modification of method 30, whereby additional steps are incorporated into method 30 to provide for securing payment (or a proxy thereof) from the vaccine consumer or the consumer's representative, generally, but not necessarily, prior to the commencement of production.

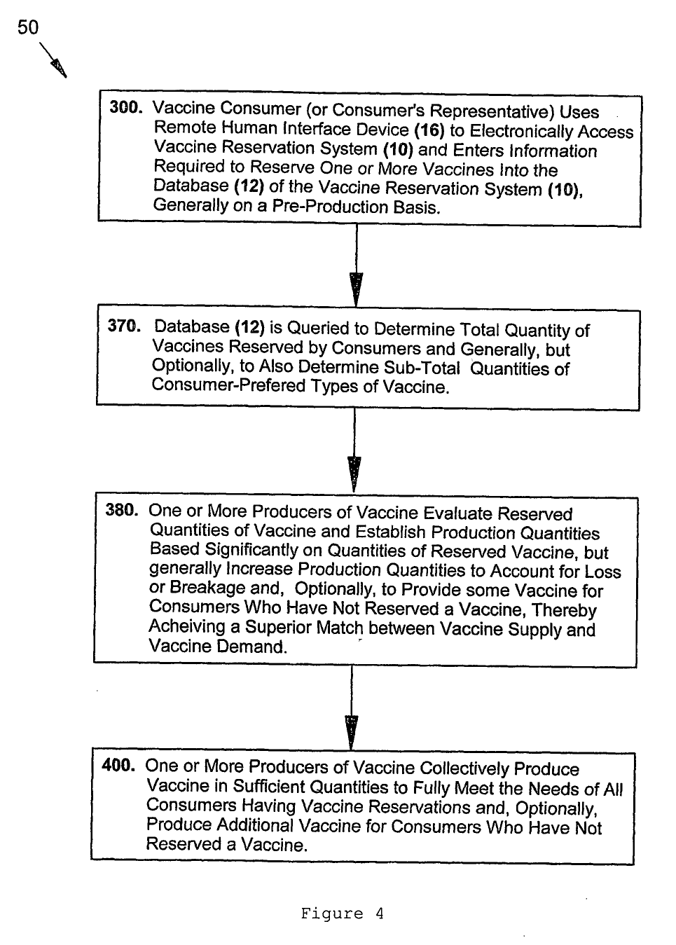

In greater detail, as shown in FIG. 4, method 40 for further mitigating the financial risk of vaccine production using the consumer-driven vaccine reservation system 10 typically comprises steps 100-600 as previously depicted in FIG. 2 (of which only steps 300 and 400 are shown in FIG. 4), but further comprises (generally, but not necessarily, between the previously defined steps 300 and 400) the following additional steps:
(310) having vaccine consumer (or a representative or a user) select a method of payment for the reserved vaccines as presented by typically (but not necessarily) remote human-interface device 16, examples of which include, but are not limited to:
   (320) having vaccine consumer (and/or consumer's representative and/or benefactor) make full or partial payment via human-interface device 16; or
   (330) having vaccine consumer (and/or consumer's representative and/or benefactor) make a security-deposit-type payment (i.e., performance inducing payment) via remote human-interface device 16, whereby such payment is fully or partially refundable upon administration of vaccine if the vaccine is then billable to (or billed to, or paid by) a third-party payer, such as an insurance company, a government health program (e.g. Medicare/Medicaid), an employer, a school, and the like; or
   (340) having vaccine consumer (and/or consumer's representative and/or benefactor) direct a third-party payer to make full or partial payment via remote human-interface device 16; and
(350) holding payments secure (such as in an escrow or trust account) for payment to the producers and/or other providers of vaccine typically (but not necessarily) either upon reservation, commencement of production, shipment, and/or the administration of vaccine, upon the latter of which any unpaid fees for such vaccines (and/or administration thereof) generally shall be paid in full and/or billed to some third party.

The specific equipment and processes for collecting payment can include any common methods, means, and/or systems known to those skilled in the art, but optionally can include, as non-limiting examples: receipt of payment via credit or debit card using internet-connected computer terminal (preferably encrypted for security), credit or debit card reader, credit or debit card transaction processing device, menu-driven telephonic payment system, conventional check by mail, automatic billing system operable to bill (typically, but not necessarily, via electronic methods) a third party (e.g., health insurance company, charitable organization, or government healthcare program, e.g., Medicaid/Medicare), and the like. Note that similar or closely related systems and/or methods optionally can be provided and operated to refund full or partial payment should the need arise, refunding a performance-inducing monetary deposit, and/or the like.

Considering that all fees for vaccines can thus be optionally paid in advance of production, method 40 of the present invention provides a highly effective method for substantially eliminating financial risk to the providers of vaccine and, in particular, to the producers of vaccine.

The basic method 40 for mitigating the financial risk of vaccine production to the producers of vaccine by collecting payment using vaccine reservation system 10 can be altered and/or supplemented in numerous ways.

In particular, method 40 also can be used to optionally provide a financial benefit or incentive to the consumer (or the consumer's representative) by providing reduced or discounted fees for reserving and/or pre-paying one or more vaccines prior to the commencement of production. Similarly, discounts can be provided for families, other groups, self-administered vaccines, and/or for numerous other conditions warranting an incentive. As a non-limiting example, system 10 and method 30 can be modified to optionally perform this function simply by further providing one or more electronic forms (or other human interface) operable collect information regarding conditions met by the user for which a financial incentive is offered, and by further providing for processing compensation based upon the incentive conditions met by the user.

The invention further provides optionally providing a substantially automated system and/or method for compensating and/or incentivizing other entities to promote vaccinations such as by providing assistance with planning, reserving, scheduling, administering, and/or otherwise performing services to promote vaccinations. As a non-limiting example, system 10 and method 30 can be modified to optionally perform this function simply by further providing one or more electronic forms (or other human interface) operable collect information regarding services performed by an individual to promote vaccinations, and by further providing for processing compensation based upon the activities performed.

The invention further provides optionally providing a substantially automated system and/or method for establishing a financial trust and/or escrow account, within which one or more benefactors can securely maintain monetary contributions such as may be used for providing compensation for vaccine to be donated, or within which the operator of system 10 can receive, hold, and/or disburse compensation for reservations made and/or as needed to operate the system 10. As a non-limiting example, system 10 and method 30 can be modified to optionally perform this function simply by further providing one or more systems and methods for establishing a financial account “on-line”, such by providing electronic forms (or other human interface) operable to collect information regarding the establishment of the account, and by further processing the collected information to establish the financial account.

The invention further provides optionally providing a substantially automated system and/or method for fundraising and/or accepting or processing charitable contributions, such as by advertising or otherwise promoting charitable fundraising events and/or by operating previously described systems and/or methods for processing compensation for donated monetary contributions.

The invention further provides optionally providing a substantially automated system and/or method for requesting and/or receiving or processing matching grants, such as by communicating a request and receiving and processing matching grant.

6. Systems and/or Methods for Facilitating Production
FIG. 4 Description and Operation as a System and/or Method for Accurately Matching Vaccine Supply and Demand:

FIG. 3 depicts an alternate embodiment 50 of the present invention optionally comprising a substantially automated system and/or method operable for accurately matching seasonal vaccine supply (i.e., production quantities) with seasonal consumer demand.

Briefly, method 50 generally entails querying the database 12 for the total number and/or type of reserved vaccines, which subsequently can be used to accurately determine the necessary production quantities, thereby mitigating both health risks due to shortage of vaccine, as well as financial risks due to overproduction of vaccine. It is noted that method 50 is generally a modification of method 30, whereby additional steps are incorporated into method 30 to accurately match seasonal vaccine supply with seasonal consumer demand.

In greater detail, as shown in FIG. 3, method 50 for accurately matching seasonal vaccine supply (i.e., production quantities) with seasonal consumer demand using the consumer-driven vaccine reservation system 10 typically comprises steps 100-600 as depicted above FIG. 2 (of which only steps 300 and 400 are shown in FIG. 3), but further comprises (generally between the previously defined steps 300 and 400) the following additional steps:
(370) querying database 12 to determine the total quantities of each type of reserved vaccine, as previously reserved by the consumer (or the consumer's representative) via vaccine reservation step 300; and
(380) establishing production quantities based significantly (or at least partially) on such total quantities of reserved vaccine, but generally increasing production quantities to account for loss and/or breakage, and optionally further increasing production quantities to provide some vaccine for consumers who have not reserved a vaccine on a pre-production basis, whereby the production quantities so established provide a far more accurate balance between seasonal vaccine supply and seasonal demand.

By using method 50 to precisely evaluate consumer demand for seasonal vaccine for a significant portion of the vaccine-consuming population, producers of vaccine are able to much more accurately and reliably match vaccine production quantities to the now significantly pre-determined consumer demand. In addition to enabling the producers of vaccine to produce the correct total number or doses of vaccine, it is emphasized that method 50 also enables the producer to produce each of several different types of vaccine in the appropriate quantities by automatically parsing and sub-totaling the records in the vaccine reservation database 12. The latter ability is particularly important considering that certain portions of the population cannot take certain types of vaccine; therefore, it is necessary to have a sufficient quantity of each medically appropriate type of vaccine, which may vary significantly in cost and/or effectiveness.

The present invention further provides optionally providing a substantially automated system and/or method for managing vaccine production facilities (and/or distribution facilities and/or vaccine administration facilities) by querying the database 12 to derive data useful for managing such facilities including, as non-limiting examples: the quantity of reserved vaccines, type of reserved vaccines, and/or anticipated locations and/or times for vaccine administration, and subsequently employing the data derived from the database as an aid in determining which production (and/or distribution and/or administration) facility or facilities to utilize to most efficiently produce (and/or distribute and/or administer) the required vaccines, considering such aspects as functional capabilities of the facility, plant capacity, proximity to the end user, and the like.

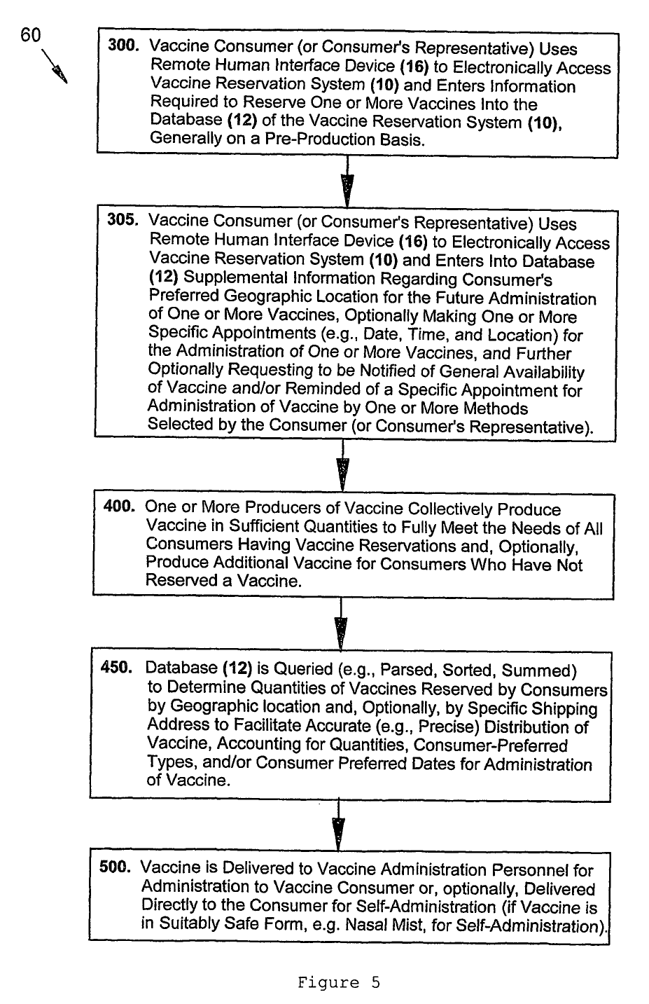

7. Systems and/or Methods for Facilitating Distribution
FIG. 5 Description and Operation as a System and/or Method for Facilitating Vaccine Distribution:

FIG. 5 depicts an alternate embodiment 60 of the present invention optionally comprising a substantially automated system and/or method for facilitating accurate (e.g., precise) global, regional, and/or local distribution of vaccine, generally by querying or parsing the consumer's geographic information contained within database 12 to determine the precise quantities of each type of vaccine to distribute (i.e., ship) to each region and/or specific address.

It is noted that method or means 60 is, once again, generally a modification of method 30, whereby additional steps are incorporated into method 30 to provide for collecting additional geographic data as required to facilitate accurate distribution, and by further including a querying or parsing step to determine the precise quantities of each type of vaccine to ship to each region and/or specific address.

In greater detail, as shown in FIG. 5, method 60 for facilitating accurate global, regional, and/or local distribution of vaccine using the consumer-driven vaccine reservation system 10 typically comprises steps 100-600 as depicted above FIG. 2 (of which only steps 300, 400, and 500 are shown in FIG. 5), but further comprising a first additional step (generally between the previously defined steps 300 and 400) and a second additional step (generally between the previously defined steps 400 and 500), including the following additional steps:
(305) having vaccine consumer (or consumer's representative) electronically access vaccine reservation system 10 typically via remote human-interface device 16 to enter into database 12 the necessary geographic and/or demographic data required to facilitate distribution of one or more vaccines, optionally further entering data as required to make a specific appointment for vaccine administration, and optionally additionally entering data as required to request an automatic notice regarding the general availability of vaccine for administration and/or a reminder of a specific appointment for vaccination; and
(450) querying database 12 to determine the total quantities of each type of reserved vaccine to distribute to each region and/or specific address, optionally accounting for consumer-preferred dates for administration.

Overall, method 60 provides a highly effective method or means for precisely distributing reserved vaccines, both geographically and temporally, thereby significantly facilitating both the distribution and timely administration of vaccine.

The invention further provides optionally providing a substantially automated system and/or method for packing and/or shipping one or more doses of one or more vaccines to one or more vaccine consumers, representatives, and/or administration personnel, generally by querying or parsing the consumer's geographic information contained within database 12 to determine the precise quantities of each type of vaccine to pack and distribute (i.e., ship) to each region and/or specific address.

The invention further provides optionally providing a substantially automated system and/or method for storing and dispensing on demand one or more doses of one or more vaccines to one or more vaccine consumers, representatives, and/or administration personnel. As a non-limiting example, system 10 and method 30 can be modified to perform this function simply by further providing one or more physical storage facilities operable to store one or more vaccines, preferably located or “pre-positioned” in close proximity to the vaccine consumer to enable rapid access to such vaccine by the vaccine consumer in a time of need, and optionally by further providing access via one or more secure electronic authorization systems and/or methods.

The invention further provides optionally providing a substantially automated system and/or method for inventorying vaccine and/or re-distributing one or more doses of one or more vaccines (optionally including donated vaccine or excess vaccine) to one or more vaccine consumers, representatives, and/or administration personnel, such as by (1) optionally further providing a substantially automatic inventorying system operable to query database 12 to determine inventory quantities, (2) optionally further providing a substantially automatic re-distribution system for redistributing excess vaccine, and/or (3) by querying database to determine excess vaccine and re-distributing excess vaccine to one or more entities in need of donated vaccine.

The invention further provides optionally providing a substantially automated system and/or method for randomizing doses of one or more vaccines to retard or inhibit targeted malicious tampering of one or more vaccines and/or doses of vaccine. This function can be implemented by further providing a randomizing system and operating the randomizing system to dispense vaccine in a random order, thereby retarding or inhibiting targeted malicious tampering of one or more vaccines and/or doses of vaccine.

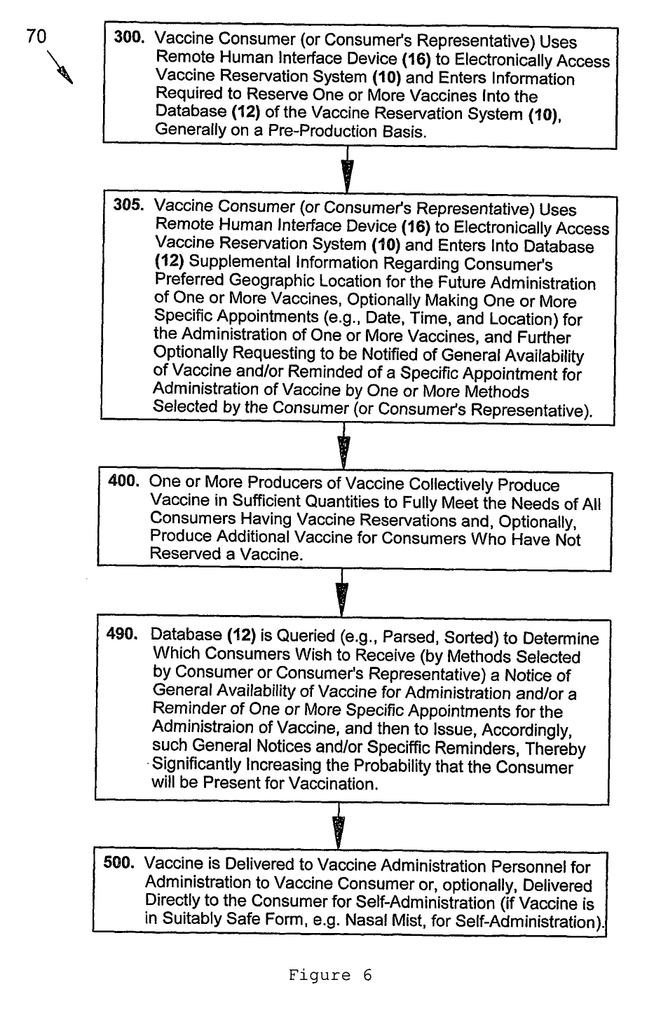

8. Systems and/or Methods for Facilitating Administration
FIG. 6 Description and Operation as a System and/or Method for Advising Consumers of Vaccine Availability:

FIG. 6 depicts an alternate embodiment 70 of the present invention optionally comprising a substantially automated system or method 70 for advising consumers of vaccine availability and/or reminding consumers of scheduled appointments for vaccine administration via automated generation and transmission of appropriate communications to such consumers.

Briefly, method 70 generally entails querying the database 12 to determine which consumers (or consumers' representatives) wish to receive an automatic announcement regarding the general availability of vaccine for administration, and/or a reminder of a specific appointment for vaccine administration. It is noted that method or means 70 is, once again, generally a modification of method 30, whereby additional steps are incorporated into method 30 to provide for collection additional geographic data as required to facilitate accurate distribution, and by further including a querying or parsing step to determine which consumers (or consumers' representatives) wish to receive an automatic announcement and, subsequently, issuing such announcement(s).

In greater detail, as shown in FIG. 6, method 70 for advising consumers (or consumers' representatives) regarding the availability of vaccine for administration using the consumer-driven vaccine reservation system 10 typically comprises steps 100-600 as depicted above FIG. 2 (of which only steps 300, 400, and 500 are shown in FIG. 6), but further comprising a first additional step (generally between the previously defined steps 300 and 400) and a second additional step (generally between the previously defined steps 400 and 500), including the following additional steps:
(305) having vaccine consumer (or consumer's representative) electronically access vaccine reservation system 10 typically via remote human-interface device 16 to enter into database 12 the necessary geographic and/or demographic data required to facilitate distribution of one or more vaccines, optionally further entering data as required to make a specific appointment for vaccine administration, and optionally additionally entering data as required to request an automatic notice regarding the general availability of vaccine for administration and/or a reminder of a specific appointment for vaccination; and
(490) querying database 12 to determine which consumers (or consumers' representatives) wish to receive an automatic announcement, and issuing such announcements to the consumers (or consumers' representatives) desiring such announcements, optionally by one or more methods selected by the consumer (or consumer's representative).

Overall, method 70 provides a highly effective method or means for increasing vaccination rates by prompting consumers to actually present themselves for vaccination.

The invention further provides optionally providing a substantially automated system and/or method operable for providing an alert or warning to one or more vaccine consumers, consumer representatives, and/or administration personnel, for example, under the circumstances that a significant adverse event occurs, which might require one or more such persons to report to a vaccination facility to receive and/or to administer one or more vaccinations. Again, as a non-limiting example, system 10 and method 30 can be modified to perform this function simply by further collecting and evaluating threat data, and under the condition that the threat data indicates a threat level exceeding a predetermined value, system 10 automatically issues such alerts and/or warnings by one or more of the many communications methods disclosed herein.

The invention further provides optionally providing a substantially automated system and/or method for managing vaccine administration personnel, facilities, and/or materiel to facilitate efficient administration of vaccinations, such as by querying the database 12 to derive data useful for managing such facilities and/or personnel including, as non-limiting examples: the quantity of reserved vaccines, type of reserved vaccines, and/or scheduled locations and/or times for vaccine administration, and subsequently employing the data derived from the database as an aid in determining which administration facilities and/or personnel to utilize to most efficiently administer vaccinations.

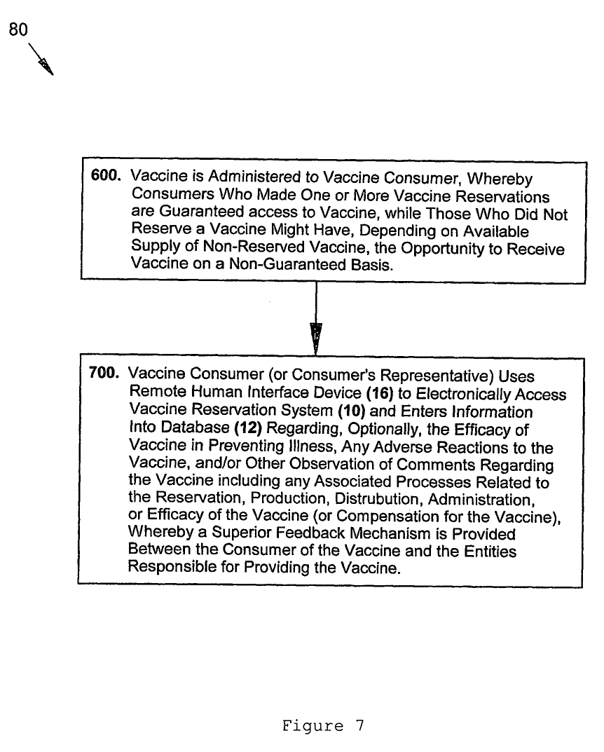

b 9. Systems and/or Methods for Evaluating Efficacy of Vaccine and/or Services
FIG. 7 Description and Operation as a System and/or Method for Obtaining Consumer Response to Vaccine:

FIG. 7 depicts an alternate embodiment 80 of the present invention comprising a substantially automated method and/or means 80 for evaluating the efficacy of, and/or any adverse reactivity to, seasonal vaccine, thereby significantly improving feedback regarding the vaccine from the consumer to the producers of vaccine and/or the broader healthcare industry.

Briefly, method 80 generally entails providing various electronic consumer feedback mechanisms, such as, for example, a telephonic survey or an interactive, fill-in type, electronic form or survey presented to the consumer via internet-connected computer or any other suitable human interface 16. It is noted that method or means 80 is generally a simple extension of method 30, whereby one additional step is appended to method 30 to provide for evaluating the efficacy of, and/or any adverse reactivity to, seasonal vaccine.

In greater detail, as shown in FIG. 7, method 80 for obtaining consumer response to vaccine using the consumer-driven vaccine reservation system 10 typically comprises steps 100-600 as depicted above FIG. 2 (of which only step 600 is shown in FIG. 7), but further comprising at least one additional step (generally appended after previously defined step 600), including, as a non-limiting example, the following additional step:
(700) having vaccine consumer (or consumer's representative) electronically access vaccine reservation system 10 typically via remote human interface 16 to enter into database 12 one or more observations and/or comments regarding the efficacy of one or more vaccines in preventing illness, one or more adverse reactions to such vaccine(s), and/or one or more other comments related to the reservation, production, distribution, and/or administration of vaccine.

Overall, method 80 provides a highly effective method for significantly improving feedback regarding the vaccine from the consumer to the producers of vaccine and/or the broader healthcare industry. It is emphasized that the data collected by such a direct consumer feedback system and/or method is highly valuable to one or more entities having an interest in improving future vaccines, improving vaccine administration services, and/or improving other items and/or services related to providing vaccine to the consumer. Such data is also valuable to vaccine consumers, their representatives, and/or their benefactors, considering that such data, whether in raw or summarized form, may be used to discriminate between a plurality vaccine providers when seeking future vaccines and/or vaccine-related services.

To facilitate communication of such valuable consumer response data to such interested entities, the present invention further provides providing one or more optional preferably (but not necessarily) substantially automated systems and/or methods for communicating such data to such interested parties. Non-limiting examples of such optional communications systems and/or methods include (1) providing direct electronic access to the consumer-provided feedback data via human interface 16 of vaccine reservation system 10, and/or (2) providing summary data derived from analyzing such consumer response data either by direct electronic access to the derived data and/or by any other practicable methods. Note that such summary data is generally derivable by querying and/or performing one or more analysis processes on the consumer response data optionally stored in database 12, and that the derived summary data may optionally include, as non-limiting examples, statistical data, quality data, performance ratings, consumer satisfaction reports, relative performance rankings of vaccine providers, and/or other data useful to the providers and/or consumers of vaccine.

The invention further provides optionally providing a substantially automated system and/or method for evaluating vaccination service provided by administration personnel, administration facilities, transaction agents, and/or for other related services, such as by providing one or more fill-in type electronic forms and subsequently using the forms to solicit opinions from one or more consumers, representatives, and/or or other related entities regarding one or more provided vaccine-related services.

10. Systems and/or Methods for Verifying Compliance with Vaccination Protocols

As another example of a modified or alternate configuration of the present invention, the invention further provides providing a substantially automated system and/or method for verifying compliance with vaccination protocols and/or requirement by one or more persons and/or groups. As a non-limiting example, one method for verifying individual and/or group compliance with one or more vaccination requirements comprises having authorized vaccine administration personnel enter an indication of vaccination compliance into a secure database 12 via human interface 16 upon vaccinating the consumer, wherein one or more Vaccination Compliance Indications (or VCIs) residing in data base 12 are subsequently accessible using human interface 16 (e.g., an Internet-connected computing device 14) by one or more entities tasked with verifying that one or more individuals are in compliance with one or more vaccination protocols and/or requirements.

In addition to providing direct access to database 12 via human interface 16 to verify compliance with vaccination requirements, the present invention further provides numerous alternate and/or supplemental substantially automated systems and/or methods for communicating one or more Vaccination Compliance Indications (VCIs) to interested entities, wherein the communication systems and/or methods optionally include, as non-limiting examples, (1) a personal vaccination record device (having the form of an identity card or other useful form) having an electronic, magnetic, and/or optical storage medium operable to receive and store one or more Vaccination Compliance Indications (VCIs), which subsequently can be read or otherwise interpreted by an appropriate reader device, (2) a radio frequency identification (RFID) device (optionally deployed sub-dermally) operable in conjunction with a RFID reader device to provide one or more Vaccination Compliance Indications (VCIs), (3) an optically scanable (e.g., barcode) vaccination compliance indication, (4) a portable secure digital electronic file, such an Adobe® Portable Data Format (PDF) file, an encrypted Extensible Markup Language (XML) file, a secure digital certificate, or other portable secure and optionally encrypted electronic file, and/or (5) a preferably substantially secure electronic link operable to transmit a one or more Vaccination Compliance Indications (VCIs) from database 12 to one or more personnel records systems (and optionally to place one or more Vaccination Compliance Indications (VCIs) directly into the appropriate individual personnel file).

While each of these methods can be useful for such purposes as facilitating international travel and others purposes, the latter item, i.e., the ability to place one or more Vaccination Compliance Indications directly into an individual personnel file would greatly facilitate various activities including, as non-limiting examples, enrolling in a school or college, taking an employment position within a company or other organization, reporting for military service, preparing for international travel, and/or making a permanent update to an individual's medical records.

In addition, such methods for verifying compliance can also serve to automatically inform an organization, such as a school or employer, that a student or employee has presented himself or herself for vaccination, thus eliminating the need to communicate such information by more convention, less efficient methods, such a written note from a doctor, a telephone call from a parent or spouse, and the like.

The invention further provides optionally providing a substantially automated system and/or method for providing insurance to one or more consumers and/or consumer representatives to provide monetary compensation in the unlikely event the consumer experiences an adverse reaction to vaccine causing financial harm to the consumer. As a non-limiting example, system 10 and method 30 can be modified to perform this function simply by further providing one or more electronic forms (or other human interface) operable to present optional insurance to the user of the system, whereby the user may choose to purchase such insurance, typically, but not necessarily, as part of the reservation and compensation processing transaction. Note that the modifications to method 30 would typically entail modifying step 300 to incorporate the noted additional aspects.

12. Systems and/or Methods for Limiting Legal and/or Financial Liability

As another example of a modified or alternate configuration of the invention, the invention further provides optionally providing a substantially automated system and/or method for limiting the legal and/or financial liability of one or more providers of vaccine, which may optionally include, as non-limiting examples: one or more vaccine producers, distributors, administrators, and/or financial transaction agents. Additionally, a consumer representative, benefactor, or donor may also be considered a provider of vaccine. Note that any of the aforementioned providers of vaccine may optionally comprise, as non-limiting examples: one or more commercial enterprises engaged in providing vaccine; governmental agencies having responsibility for the reliable production and/or administration of vaccine; non-governmental organizations (optionally, but not necessarily, charitable) involved in providing vaccine or vaccination services; individual persons; and/or other entities, each of which may be exposed to significant legal and or financial liability in the event that (1) suitable vaccine is not made available on a timely basis, (2) a vaccine consumer has an adverse (e.g., allergic) reaction to an administered vaccine (despite typically being screened for possible allergies prior to administration), and/or (3) other adverse unintended consequences or circumstances related to the production, distribution, and/or administration of vaccine. As a non-limiting example, system 10 and method 30 can be modified to perform this function simply by further providing one or more electronic forms (or other human interface) operable to present a legal liability waiver to the user of the system, whereby the user must indicate acceptance of the terms of the liability waiver (or liability limitation) as a condition of completing a vaccine reservation. Note that the modifications to method 30 would typically entail modifying step 300 to incorporate the noted additional aspects.

### Operation as a Mechanism for Reducing Governmental Responsibility:

The present invention provides a unique means for transferring responsibility for individual consumer access to vaccine to the particular vaccine-consuming individual, thus substantially removing from government health agencies and/or other agencies operating in the public's interest the burden of responsibility for ensuring individual access to vaccine.

13. Systems and/or Methods for Securing and Updating Information

### Information Security Means:

To provide adequate security of the consumer's personal information (non-limiting examples of which include: identification data, financial data, medical data, and the like), the present invention fully provides and anticipates the need to use secure techniques for electronic storage and/or transmission of such data. Accordingly, any of the devices, methods, and/or processes described herein are considered to optionally incorporate, where practical, preferably state-of-the-art data-encryption protocols, firewalls, and/or other security features, as well as any legislatively mandated protocols for protecting or securing the privacy of patient medical records, consumer financial data, and/or other sensitive or private consumer data.

### Information Update Means:

To facilitate many of the above methods or functions of the present invention, note that the present invention further provides various well-known, substantially automated, systems, methods, and/or means for updating, correcting, or otherwise revising, any information provided to reserve, make payment for, produce, distribute, store, administer, evaluate, and/or otherwise process vaccine.

It will be readily understood that the inventive subject matter may be executed in various detailed processes, leading to the same effective result. Thus, one of ordinary skill in the art will appreciate the variability of such factors and would be able to create specific computer programs capable of executing the system functions and method steps described herein, using no more than routine experimentation.

Thus, the extensive applicability of the fundamental consumer-driven, pre-production, seasonal vaccine reservation system for facilitating the efficient production, distribution, administration and/or post-administration evaluation of health-critical, long-production-lead-time seasonal vaccines has been disclosed. The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the following claims.

We claim:

1. An automated, consumer-driven, vaccine reservation management system configured to substantially guarantee a vaccine consumer access to a dose of vaccine, comprising the following elements, operably connected:
(a) at least one electronic database configured to receive and store vaccine reservation management information;
(b) at least one electronic computer system having at least one storage medium configured for hosting said electronic database;
(c) at least one human interface for enabling said vaccine reservation management information to be communicated between said electronic database system and a system user; and
(d) client software residing on said at least one storage medium providing an interface to said at least one database and operable for processing vaccine reservation management information,
i. said client software is operable for enabling a user desiring to reserve a dose of vaccine to reserve at least one dose of vaccine on a pre-production basis,
ii. said client software is operable for processing financial compensation for a at least one reserved dose of vaccine,
iii. said client software is operable for providing vaccine reservation management information to a system user for use by at least one vaccine producer for determining seasonal vaccine production and/or distribution quantity, or
iv. combinations of i. ii. and iii.

2. A consumer-driven vaccine planning and management system for managing consumer vaccines and, optionally, related user medical information, comprising the following elements, operably connected:
(a) at least one electronic database configured to receive and store vaccine planning and management information;
(b) at least one electronic computer system having at least one storage medium configured for hosting said electronic database;
(c) at least one human interface for enabling said vaccine planning and management information to be communicated between said electronic database system and a system user; and
(d) client software residing on said at least one storage medium providing an interface to said at least one database and operable for processing vaccine planning and management information,
wherein the system is further characterized as having
i. a vaccine planning system,
ii. a screening system for evaluating medical appropriateness of a vaccine for a specific consumer based upon consumer-specific data provided to system,
iii. a vaccine reservation system,
iv. a vaccine administration appointment scheduling system,
v. a vaccination registry system optionally interoperable with one or more other record systems,
vi. a registry of consumer medical conditions relevant to vaccine or vaccination,
vii. a vaccine requirements system operable to identify required consumer vaccines based upon consumer-specific data and optionally other data provided to system,
viii. one or more unique consumer identifying systems or means,
ix. a physician approval system for allowing a physician to electronically approve a consumer vaccination plan, a consumer-reserved vaccine, a consumer vaccination record, or a combination thereof, or
x. a combination thereof.

3. The vaccine planning and management system of claim 2, wherein the vaccine or vaccination relates to one or more pharmacological agents selected from the group consisting of:
(a) pediatric vaccine(s) or vaccination(s);
(b) adult vaccine(s) or vaccination(s);
(c) seasonal vaccine(s) or vaccination(s);
(d) emergency vaccine(s) or vaccination(s);
(e) travel vaccines(s) or vaccination(s);
(f) anti-viral pharmacological agent(s);
(g) anti-biotic pharmacological agent(s);
(h) or a combination thereof.

4. The vaccine planning and management system of claim 2, further comprising a subsystem for displaying public service messages, commercial advertisements, or both.

5. The vaccine planning and management system of claim 4, further comprising a compensation system for securing payment for advertising.

6. The vaccine planning and management system of claim 5, wherein the compensation system is automated.

7. The vaccine planning and management system of claim 2, further comprising supplemental and/or alternate vaccine reservation functions selected from the group consisting of charitably gifting (i.e., donating) one or more vaccines, registering those in need of a charitably gifted or donated vaccine, and a combination thereof.

8. A system for donating vaccines or other medical material or services to a recipient comprising:
(a) at least one electronic database configured to receive and store information relating to vaccines or other medical material or services to be donated;
(b) at least one electronic computer system having at least one storage medium configured for hosting said electronic database;
(c) at least one human interface for enabling said vaccine planning and management information to be communicated between said electronic database system and a system user; and
(d) client software residing on said at least one storage medium providing an interface to said at least one database and operable for processing information for donating vaccines or other medical material or services,
wherein the system is further characterized as comprising
(i) a donation system operable to donate one or more vaccines reserved by or for a user,
(ii) a donation system operable to donate one or more vaccines owned by a user,
(iii) a donation system operable to donate funding for one or more user-specified vaccines, vaccination services, or combination thereof,
(iv) a donation system operable to register one or more entities in need of a donation or charitable gift of vaccine, vaccination service, or other medical material or service,
(v) a donation system operable to donate or charitably gift one or more vaccines, vaccination services, funding for one or more user-specified vaccines or vaccination services, or combination thereof, to one or more user-specified or user selectable recipient(s) in need of the donation or charitable gift, or
(vi) a combination thereof.

9. The system for donating vaccines or other medical material or services of claim 8, wherein the recipient in need of said donation or charitable gift is selected from the group consisting of:
(a) an individual person;
(b) a family of individual persons;
(c) a group or association of individual persons;
(d) a nursery;
(e) an orphanage;
(f) a clinic or hospital;
(g) a classroom;
(h) a school;
(i) a village;
(j) a town or city;
(k) a county;
(l) a sub-national state or province;
(m) a nation or state; and
(n) a continent.

10. The system for donating vaccines or other medical material or services of claim 8, wherein the donated vaccine or medical material or service relates to one or more pharmacological agents selected from the group consisting of:
(a) pediatric vaccine(s) or vaccination(s),
(b) adult vaccine(s) or vaccination(s),
(c) seasonal vaccine(s) or vaccination(s),
(d) emergency vaccine(s) or vaccination(s),
(e) travel vaccine(s) or vaccination(s),
(f) anti-viral pharmacological agent(s),
(g) anti-biotic pharmacological agent(s), or
(h) a combination thereof.

11. The system for donating vaccines or other medical material or services of claim 8, further comprising a subsystem for displaying public service messages, commercial advertisements, or both.

12. The system for donating vaccines or other medical material or services of claim 11, further comprising an a compensation system for securing payment for advertising.

13. The system for donating vaccines or other medical material or services of claim 12, wherein the compensation system is automated.

14. The system for donating vaccines or other medical material or services of claim 8, wherein at least a portion of the compensation is donated to a recipient in need of donated vaccine, vaccinations service, or other medical materials or services.

15. The system for donating vaccines or other medical material or services of claim 14, wherein the recipient in need of said donation or charitable gift is selected from the group consisting of:
(a) an individual person;
(b) a family of individual persons;
(c) a group or association of individual persons;
(d) a nursery;
(e) an orphanage;
(f) a clinic or hospital;
(g) a classroom;
(h) a school;
(i) a village;
(j) a town or city;
(k) a county;
(l) a sub-national state or province;
(m) a nation or state; and
(n) a continent.

16. The system for donating vaccines or other medical material or services of claim 14, wherein a donation is tax-deductible and the system provides a donor with a receipt documenting the donation.

17. The system for donating vaccines or other medical material or services of claim 8, wherein the system is at least partially consumer-operated.

18. The system for donating vaccines or other medical material or services of claim 8, wherein one or more of elements (i)-(vi) is consumer-operated.

19. The system for donating vaccines or other medical material or services of claim 8, wherein the system is fully consumer-operated.
